(19) United States
(12) Patent Application Publication
(10) Pub. No.: US 2014/0356779 A1
(43) Pub. Date: Dec. 4, 2014

(54) BLACK TONER CONTAINING COMPOUND HAVING AZO SKELETON

(71) Applicant: CANON KABUSHIKI KAISHA, Tokyo (JP)

(72) Inventors: Waka Hasegawa, Tokyo (JP); Yasuaki Murai, Kawasaki-shi (JP); Yuki Hasegawa, Yokohama-shi (JP); Takayuki Toyoda, Yokohama-shi (JP); Masatake Tanaka, Yokohama-shi (JP); Masashi Kawamura, Yokohama-shi (JP); Masashi Hirose, Machida-shi (JP)

(73) Assignee: CANON KABUAHIK KAISHA, Tokyo (JP)

(21) Appl. No.: 14/374,036

(22) PCT Filed: Feb. 22, 2013
(86) PCT No.: PCT/JP2013/055604

§ 371 Date: Jul. 23, 2014

(30) Foreign Application Priority Data
Feb. 29, 2012 (JP) 2012-043072

(51) Int. Cl. G03G 9/08; G03G 9/087; G03G 9/09

(52) U.S. Cl. CPC G03G 9/08; G03G 9/0904; G03G 9/087
USPC 430/108.22

(57) ABSTRACT

Provided is a black toner which has improved dispersibility of carbon black in a binding resin and has a high coloring power. Also provided is a black toner which suppresses fogging and has high transfer efficiency. The toner includes a toner particle containing a binding resin, a compound in which a polymer moiety is bound to an azo skeleton, and carbon black as a coloring agent.

### TECHNICAL FIELD

The present invention relates to a black toner to be used in electrophotography, electrostatic recording, electrostatic printing, or toner jet recording, which contains, as a dispersant for carbon black, a compound having an azo skeleton structure.

### BACKGROUND ART

Carbon black is generally used as a toner coloring agent for a black toner. However, the carbon black has a small primary particle diameter as compared to other pigments, and forms a structure. As the structure becomes smaller, it becomes more difficult to disperse the carbon black. When dispersibility of the carbon black in a toner particle is insufficient, a reduction in coloring power of a toner occurs. Further, the carbon black is conductive, and hence the dispersibility of the carbon black also affects toner chargeability. That is, when the dispersibility of the carbon black in the toner particle is insufficient, the toner chargeability lowers owing to, for example, aggregation, uneven distribution, or exposure on a toner surface of the carbon black in the toner particle, which causes “fogging,” in which a toner is developed in a margin of an image, and an image defect due to a reduction in transfer efficiency of a toner.

There are proposals concerning various pigment dispersants for improving the dispersibility of the carbon black in the toner particle. For example, Patent Literature 1 discloses a toner containing a block copolymer or graft copolymer obtained by polymerizing a styrene-based monomer and an acrylic acid ester-based (or methacrylic acid ester-based) monomer, carbon black, and a binding resin.

In addition, Patent Literature 2 discloses a toner composition including modified carbon black to which an organic group having an aryl group is bonded or carbon black to which at least one kind of phenyl-containing polymer is adsorbed.

In addition, Patent Literature 3 discloses a method of producing a toner particle containing a compound having an amide group and a zinc phthalocyanine compound.

### CITATION LIST

### Patent Literature

PTL 1: Japanese Patent No. 3285623
PTL 2: Japanese Patent Translation Publication No. 2010-529502
PTL 3: Japanese Patent No. 4510687

### SUMMARY OF INVENTION

### Technical Problem

In the method involving causing a polymer to adsorb to carbon black as described in each of Patent Literature 1 and Patent Literature 2, the polymer has an insufficient affinity for carbon black, and hence sufficient dispersibility cannot be obtained, with the result that an improvement in a coloring power, fogging suppression, and transfer efficiency of the toner, and the like, which are required for a high-definition image, have not yet been satisfied. Meanwhile, the method involving chemical bonding to carbon black as described in Patent Literature 2 is disadvantageous in terms of production cost of the toner because of its complicated production steps, although satisfactory dispersibility of carbon black is obtained by chemically modifying the carbon black in advance. In addition, although satisfactory dispersibility of carbon black is obtained in the production method involving using the compound as described in Patent Literature 3, it is necessary to provide a black toner having additionally improved dispersibility of carbon black in order to satisfy a demand for an output image having additionally high image quality in recent years.

Thus, an object of the present invention is to provide a black toner which has improved dispersibility of carbon black in a binding resin and has a high coloring power. Another object of the present invention is to provide a black toner which suppresses fogging and has high transfer efficiency.

### Solution to Problem

The above-mentioned objects are achieved by the present invention described below.

That is, the present invention provides a black toner, including:
a binding resin;
a compound in which a partial structure represented by the following formula (1) is bound to a polymer moiety having a monomer unit represented by the following formula (2); and
carbon black as a coloring agent:

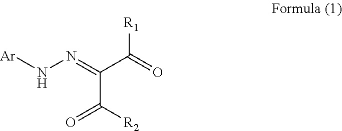

in the formula (1):
at least one of R₁, R₂, and Ar is bound to the polymer moiety with a linking group or a single bond;
R₁ and R₂ not bound to the polymer moiety each independently represent an alkyl group, a phenyl group, an OR₅ group, or an NR₆R₇ group, and Ar not bound to the polymer moiety represents an aryl group;
R₁ and R₂ bound to the polymer moiety each independently represent a divalent group obtained by removing a hydrogen atom from an alkyl group, a phenyl group, or an OR₅ or NR₆R₇ group, and Ar bound to the polymer moiety represents a divalent group obtained by removing a hydrogen atom from an aryl group; and
R₅ to R₇ each independently represent a hydrogen atom, an alkyl group, a phenyl group, or an aralkyl group; and

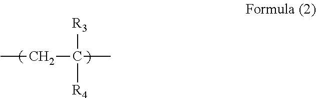

in the formula (2):
R₃ represents a hydrogen atom or an alkyl group; and
R₄ represents a phenyl group, a carboxyl group, a carboxylic acid ester group, or a carboxylic acid amide group.

### Advantageous Effects of Invention

According to the present invention, it is possible to provide the black toner which has a high coloring power, suppresses fogging, and has high transfer efficiency.

Further features of the present invention will become apparent from the following description of exemplary embodiments with reference to the attached drawings.

### BRIEF DESCRIPTION OF DRAWINGS

FIG. 1 is a chart showing a ¹H NMR spectrum of Compound (101) having an azo skeleton structure in CDCl₃ at room temperature and 400 MHz.

FIG. 2 is a chart showing a ¹H NMR spectrum of Compound (107) having an azo skeleton structure in CDCl₃ at room temperature and 400 MHz.

FIG. 3 is a chart showing a ¹³C NMR spectrum of Compound (115) having an azo skeleton structure in CDCl₃ at room temperature and 400 MHz.

FIG. 4 is a chart showing a ¹³C NMR spectrum of Compound (147) having an azo skeleton structure in CDCl₃ at room temperature and 400 MHz.

FIG. 5 is a chart showing a ¹³C NMR spectrum of Compound (148) having an azo skeleton structure in CDCl₃ at room temperature and 400 MHz.

FIG. 6 is a chart showing a ¹³C NMR spectrum of Compound (151) having an azo skeleton structure in CDCl₃ at room temperature and 400 MHz.

FIG. 7 is a chart showing a ¹³C NMR spectrum of Compound (153) having an azo skeleton structure in CDCl₃ at room temperature and 400 MHz.

FIG. 8 is a scanning electron micrograph of a cross-section of a toner of the present invention (TNR28).

FIG. 9 is a scanning electron micrograph of a cross-section of a comparative toner (TNR115).

### DESCRIPTION OF EMBODIMENTS

Hereinafter, the present invention is described in detail by way of suitable embodiments.

The toner according to the present invention includes a binding resin, a compound in which a partial structure represented by the following formula (1) is bound to a polymer moiety having a monomer unit represented by the following formula (2), and carbon black as a coloring agent.

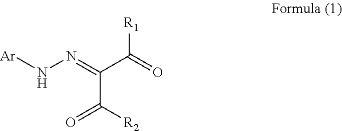

In the formula (1): at least one of R₁, R₂, and Ar is bound to the polymer moiety with a linking group or a single bond; R₁ and R₂ not bound to the polymer moiety each independently represent an alkyl group, a phenyl group, an OR₅ group, or an NR₆R₇ group, and Ar not bound to the polymer moiety represents an aryl group; R₁ and R₂ bound to the polymer moiety each independently represent a divalent group obtained by removing a hydrogen atom from an alkyl group, a phenyl group, or an OR₅ or NR₆R₇ group, and Ar bound to the polymer moiety represents a divalent group obtained by removing a hydrogen atom from an aryl group; and R₅ to R₇ each independently represent a hydrogen atom, an alkyl group, a phenyl group, or an aralkyl group.]

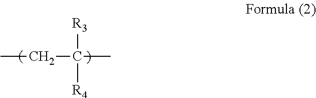

[In the formula (2): R₃ represents a hydrogen atom or an alkyl group; and R₄ represents a phenyl group, a carboxyl group, a carboxylic acid ester group, or a carboxylic acid amide group.]

The compound in which the partial structure represented by the formula (1) is bound to the polymer moiety having the monomer unit represented by the formula (2) has high affinities for a water-insoluble solvent, a polymerizable monomer, and a binding resin for a toner, and has a high affinity for carbon black. Hence, when the compound is used as a dispersant, there is provided a black toner which includes carbon black satisfactorily dispersed in a binding resin and has a high coloring power. In addition, when the compound having the partial structure represented by the formula (1) is added to a black toner, there is provided a black toner which suppresses fogging and has high transfer efficiency.

It should be noted that the partial structure represented by the formula (1) is also referred to as “azo skeleton structure.” Further, the compound in which the azo skeleton structure is bound to the polymer moiety having the monomer unit represented by the formula (2) is also referred to as “compound having an azo skeleton structure.” In addition, the polymer moiety having the monomer unit represented by the formula (2) to which the azo skeleton structure is not bound is also referred to as “polymer moiety.”

First, the compound having an azo skeleton structure is described.

The compound having an azo skeleton structure is constructed of an azo skeleton structure represented by the formula (1), which has a high affinity for carbon black, and a polymer moiety having a monomer unit represented by the formula (2), which has a high affinity for a water-insoluble solvent.

First, the azo skeleton structure represented by the formula (1) is described in detail.

Examples of the alkyl group in R₁ and R₂ in the formula (1) include linear, branched, or cyclic alkyl groups such as a methyl group, an ethyl group, a n-propyl group, a n-butyl group, a n-pentyl group, a n-hexyl group, an isopropyl group, an isobutyl group, a sec-butyl group, a tert-butyl group, and a cyclohexyl group.

Examples of the alkyl group in R₅ to R₇ in the OR₅ group and NR₆R₇ group in the formula (1) include linear, branched, or cyclic alkyl groups such as a methyl group, an ethyl group, a n-propyl group, a n-butyl group, a n-pentyl group, a n-hexyl group, an isopropyl group, an isobutyl group, a sec-butyl group, a tert-butyl group, and a cyclohexyl group.

Examples of the aralkyl group in R₅ to R₇ in the OR₅ group and NR₆R₇ group in the formula (1) include a benzyl group and a phenethyl group. R₁ and R₂ in the formula (1) may be further substituted by a substituent group as long as an affinity for carbon black is not significantly inhibited. In this case, examples of the substituent group which may be used for the substitution include a halogen atom, a nitro group, an alkyl group, an amino group, a hydroxyl group, a cyano group, and a trifluoromethyl group.

It is preferred that R₁ in the formula (1) represents a methyl group in consideration of an affinity for carbon black.

It is preferred that R₂ in the formula (1) represents an NR₆R₇ group, where R₆ represent a hydrogen atom and R₇ represent a phenyl group, from the viewpoint of an affinity for carbon black.

Ar in the formula (1) represents an aryl group, and examples thereof include a phenyl group and a naphthyl group.

Ar in the formula (1) may be further substituted by a substituent group as long as an affinity for carbon black is not significantly inhibited. In this case, examples of the substituent group which may be used for the substitution include an alkyl group, an alkoxy group, a halogen atom, a hydroxyl group, a cyano group, a trifluoromethyl group, a carboxyl group, a carboxylic acid ester group, and a carboxylic acid amide group.

At least one of R₁, R₂, and Ar in the formula (1) is bound to the polymer moiety with a linking group or a single bond. R₁ and R₂ bound to the polymer moiety each independently represent a divalent group obtained by removing a hydrogen atom from an alkyl group, a phenyl group, or an OR₅ or NR₆R₇ group, and Ar bound to the polymer moiety represents a divalent group obtained by removing a hydrogen atom from an aryl group. In this case, the linking group is not particularly limited as long as it is a divalent linking group, but is preferably a bond including a carboxylic acid ester bond, a carboxylic acid amide bond, or a sulfonic acid ester bond from the viewpoint of easiness of production. In particular, a bond including a secondary amide bond, which is synthesized in a high yield and has high bond stability, is more preferred.

Further, it is preferred that the partial structure represented by the formula (1) be represented by the following formula (3) from the viewpoint of an affinity for carbon black.

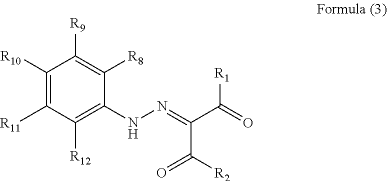

[In the formula (3): R₁ and R₂ each independently represent an alkyl group, a phenyl group, an OR₅ group, or an NR₆R₇ group; R₈ to R₁₂ each independently represent a hydrogen atom, a COOR₁₃ group, or a CONR₁₄R₁₅ group; R₁₃ to R₁₅ each independently represent a hydrogen atom, an alkyl group, a phenyl group, or an aralkyl group; and at least one of R₁, R₂, and R₈ to R₁₂ has a moiety to be bound to the polymer moiety described in the formula (2).]

Examples of the alkyl group in R₁₃ to R₁₅ in the formula (3) include a methyl group, an ethyl group, a n-propyl group, and an isopropyl group.

Examples of the aralkyl group in R₁₃ to R₁₅ in the formula (3) include a benzyl group and a phenethyl group.

It is preferred that at least one of R₈ to R₁₂ in the formula (3) represent a COOR₁₃ group or a CONR₁₄R₁₆ group from the viewpoint of an affinity for carbon black.

In addition, it is preferred that R₁₃ represent a methyl group, R₁₄ represent a hydrogen atom, and R₁₆ represent a methyl group or a hydrogen atom from the viewpoint of an affinity for carbon black.

At least one of R₁, R₂, and R₈ to R₁₂ in the formula (3) has a moiety to be bound to the polymer moiety. It is particularly preferred that R₂ represent an NR₆R₇ group, where R₆ represent a hydrogen atom and R₇ represent a phenyl group having a moiety to be bound to the polymer moiety, from the viewpoints of an affinity for carbon black and easiness of production.

It is preferred that the partial structure represented by the formula (1) be represented by the following formula (4) or (5) from the viewpoint of an affinity for carbon black.

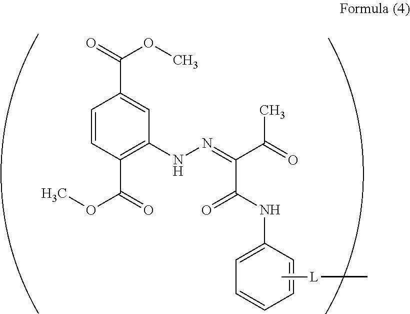

In the formula (4), L represents a divalent linking group to be bound to the polymer moiety having the monomer unit represented by the formula (2).]

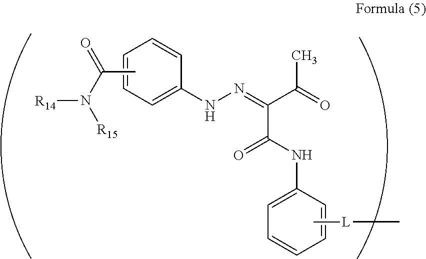

In the formula (5), R₁₄ and R₁₅ each independently represent a hydrogen atom, an alkyl group, a phenyl group, or an aralkyl group, and L represents a divalent linking group to be bound to the polymer moiety having the monomer unit represented by the formula (2).]

The linking group L to the polymer moiety in the formula (4) or (5) is not particularly limited as long as it is a divalent linking group, but is preferably a bond including a carboxylic acid ester bond, a carboxylic acid amide bond, or a sulfonic acid ester bond from the viewpoint of easiness of production. In particular, a bond including a secondary amide bond, which is synthesized in a high yield and has high bond stability, is more preferred.

A difference in position at which the azo skeleton is substituted by the linking group L in the formula (4) or (5) does not affect an affinity for carbon black.

As the substitution positions of the carboxylic acid amide in the formula (5), there are given cases where the substitution positions are the o-position, m-position, and p-position with respect to the azo group. Of those, cases where the substitution positions are the m-position and p-position are preferred from the viewpoint of an affinity for carbon black.

As the substitution positions of CONR₁₄R₁₅ in the formula (5), there are given cases where the substitution positions are the o-position, m-position, and p-position with respect to the azo group. Of those, cases where the substitution positions are the m-position and p-position are preferred from the viewpoint of an affinity for carbon black.

Next, the polymer moiety having the monomer unit represented by the formula (2) is described in detail.

The alkyl group in R₃ in the formula (2) is not particularly limited, and examples thereof include linear, branched, or cyclic alkyl groups such as a methyl group, an ethyl group, a n-propyl group, a n-butyl group, a n-pentyl group, a n-hexyl group, an isopropyl group, an isobutyl group, a sec-butyl group, a tert-butyl group, and a cyclohexyl group.

It is preferred that R₃ in the formula (2) represents a hydrogen atom or a methyl group from the viewpoint of the polymerizability of a polymerizable monomer for forming the monomer unit.

The carboxylic acid ester group in R₄ in the formula (2) is not particularly limited, and examples thereof include linear or branched ester groups such as a methyl ester group, an ethyl ester group, a n-propyl ester group, an isopropyl ester group, a n-butyl ester group, an isobutyl ester group, a sec-butyl ester group, a tert-butyl ester group, an octyl ester group, a nonyl ester group, a decyl ester group, an undecyl ester group, a dodecyl ester group, a hexadecyl ester group, an octadecyl ester group, an eicosyl ester group, a docosyl ester group, a 2-ethylhexyl ester group, a phenyl ester group, and a 2-hydroxyethyl ester group.

Examples of the carboxylic acid amide group in R₄ in the formula (2) include linear or branched amide groups such as an N-methylamide group, an N,N-dimethylamide group, an N-ethylamide group, an N,N-diethylamide group, an N-isopropylamide group, an N,N-diisopropylamide group, an N-n-butylamide group, an N,N-di-n-butylamide group, an N-isobutylamide group, an N,N-diisobutylamide group, an N-sec-butylamide group, an N,N-di-sec-butylamide group, an N-tert-butylamide group, an N-octylamide group, an N,N-dioctylamide group, an N-nonylamide group, an N,N-dinonylamide group, an N-decylamide group, an N,N-didecylamide group, an N-undecylamide group, an N,N-diundecylamide group, an N-dodecylamide group, an N,N-didodecylamide group, an N-hexadecylamide group, an N-octadecylamide group, an N-phenylamide group, an N-(2-ethylhexyl)amide group, and an N,N-di(2-ethylhexyl)amide group.

R₄ in the formula (2) may be further substituted, and is not particularly limited as long as the polymerizability of a polymerizable monomer for forming a monomer unit is not inhibited and the solubility of the compound having an azo skeleton structure is not significantly reduced. In this case, examples of the substituent group which may be used for the substitution include: alkoxy groups such as a methoxy group and an ethoxy group; amino groups such as an N-methylamino group and an N,N-dimethylamino group; acyl groups such as an acetyl group; and halogen atoms such as a fluorine atom and a chlorine atom.

It is preferred that R₄ in the formula (2) represent a phenyl group, a carboxylic acid ester group, or a carboxylic acid amide group from the viewpoints of the dispersibility of the compound having an azo skeleton structure in a binding resin for a toner and the compatibility of the compound with the resin.

The affinity of the polymer moiety for a dispersion medium may be controlled by changing the ratio of the monomer unit represented by the formula (2). When the dispersion medium is a non-polar solvent such as styrene, it is preferred to increase the ratio of the monomer unit represented by the formula (2) where R₄ represents a phenyl group from the viewpoint of the affinity for the dispersion medium. In addition, when the dispersion medium is a solvent having polarity to some degree such as an acrylic acid ester, it is preferred to increase the ratio of the monomer unit represented by the formula (2) where R₄ represents a carboxyl group, a carboxylic acid ester group, or a carboxylic acid amide group from the viewpoint of the affinity for the dispersion medium.

With regard to the molecular weight of the polymer moiety, the case where the number average molecular weight is 500 or more is preferred from the viewpoint of improving the dispersibility of carbon black. A larger molecular weight leads to a higher effect of improving the dispersibility of carbon black. However, an excessively large molecular weight is not preferred because a reduction in affinity for a water-insoluble solvent is liable to occur. Thus, the case where the number average molecular weight of the polymer moiety is 200,000 or less is preferred. In addition to the foregoing, the case where the number average molecular weight of the polymer moiety falls within the range of 2,000 to 50,000 is more preferred in consideration of easiness of production.

In addition, as disclosed in Japanese Patent Translation Publication No. 2003-531001, there is known a method of improving dispersibility involving introducing a branched aliphatic chain into a terminal in a polyoxyalkylene carbonyl-based dispersant. In the polymer site of the present invention as well, when a telechelic polymer moiety is synthesized by a method such as atom transfer radial polymerization (ATRP) to be described later, a branched aliphatic chain can be introduced into a terminal, possibly resulting in improved dispersibility.

In the compound having an azo skeleton structure, azo skeleton structures may be located at random, or may be unevenly located so that one or more blocks may be formed at one terminal.

In the compound having an azo skeleton structure, a larger number of azo skeleton structures lead to a higher affinity for carbon black. However, an excessively large number of azo skeleton structures are not preferred because a reduction in affinity for a water-insoluble solvent is liable to occur. Thus, with respect to 100 monomers for forming the polymer moiety, the case where the number of azo skeleton structures falls within the range of 0.2 to 10 is preferred, and the case where the number of azo skeleton structures falls within the range of 0.2 to 5 is more preferred.

As illustrated in the drawing below, tautomers represented by, for example, the following formulae (6) and (6′) exist in the azo skeleton structure represented by the formula (1), and these tautomers also fall within the scope of the present invention.

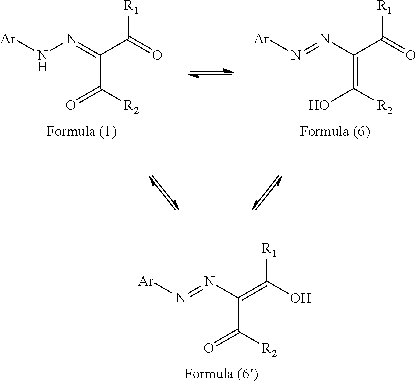

[R₁, R₂, and Ar in the formulae (6) and (6′) have the same meanings as R₁, R₂, and Ar in the formula (1), respectively.]

The compound having an azo skeleton structure may be synthesized according to a known method.

A method of synthesizing the compound having an azo skeleton structure is exemplified by the following methods (i) to (iv).

First, the method (i) is described in detail by showing an example of its scheme below.

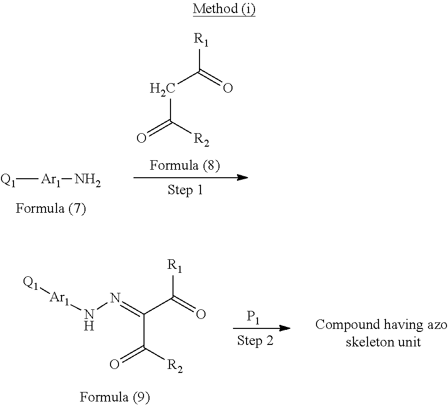

[R₁ and R₂ in the formulae (8) and (9) have the same meanings as R₁ and R₂ in the formula (1), respectively. Ar₁ in the formulae (7) and (9) represents an arylene group. P₁ represents a polymer site obtained by polymerizing a polymerizable monomer for forming the monomer unit represented by the formula (2). Q₁ in the formulae (7) and (9) represents a substituent group which reacts with P₁ to form the divalent linking group L.]

In the method (i) shown as an example in the foregoing, the compound having an azo skeleton structure may be synthesized by: Step 1 of subjecting an aniline derivative represented by the formula (7) and a compound (8) to diazo coupling to synthesize an azo compound (9); and Step 2 of linking the azo compound (9) to a polymer moiety P₁ through a condensation reaction or the like.

First, Step 1 is described. In Step 1, a known method may be utilized. For example, there is given a method shown below. First, the aniline derivative (7) is subjected to a reaction with a diazotization agent such as sodium nitrite or nitrosylsulfuric acid in a methanol solvent in the presence of an inorganic acid such as hydrochloric acid or sulfuric acid, to thereby synthesize a corresponding diazonium salt. Further, the diazonium salt is coupled with the compound (8) to synthesize the azo compound (9).

Many kinds of commercially available products of the aniline derivative (7) are easily available. Further, the aniline derivative (7) may be easily synthesized by a known method.

This step may be performed without using any solvent, but is preferably performed in the presence of a solvent in order to prevent the reaction from proceeding abruptly. The solvent is not particularly limited as long as it does not inhibit the reaction. Examples thereof include: alcohols such as methanol, ethanol, and propanol; esters such as methyl acetate, ethyl acetate, and propyl acetate; ethers such as diethyl ether, tetrahydrofuran, and dioxane; hydrocarbons such as benzene, toluene, xylene, hexane, and heptane; halogen-containing hydrocarbons such as dichloromethane, dichloroethane, and chloroform; amides such as N,N-dimethylformamide, N-methylpyrrolidone, and N,N-dimethylimidazolidinone; nitriles such as acetonitrile and propionitrile; acids such as formic acid, acetic acid, and propionic acid; and water. Further, the solvents may be used as a mixture of two or more kinds thereof, and a mixing ratio upon the mixed use may be set to any ratio depending on the solubility of a solute. The usage of the solvent may be set to any usage, but preferably falls within the range of 1.0 to 20 times by weight with respect to the compound represented by the formula (7) from the viewpoint of a reaction rate.

This step is generally performed in the temperature range of −50° C. to 100° C., and is generally completed within 24 hours.

Next, a method of synthesizing the polymer moiety P₁ to be used in Step 2 is described. A known polymerization method may be utilized in the synthesis of the polymer moiety P₁ (for example, Krzysztof Matyjaszewski and one other, “Chemical Reviews,” (USA), American Chemical Society, 2001, 101, 2921-2990).

Specific examples thereof include radical polymerization, cationic polymerization, and anionic polymerization. Of those, radical polymerization is preferably employed from the viewpoint of easiness of production.

The radical polymerization may be performed by, for example, use of a radical polymerization initiator, irradiation with radiation, laser light, or the like, combined use of a photopolymerization initiator and photoirradiation, and heating.

The radical polymerization initiator has only to be a compound which can generate a radical and initiate a polymerization reaction, and is selected from compounds which generate radicals through actions of heat, light, radiation, an oxidation reduction reaction, and the like. Examples thereof include azo compounds, organic peroxides, inorganic peroxides, organometallic compounds, and photopolymerization initiators. More specific examples thereof include: azo-based polymerization initiators such as 2,2′-azobis(isobutyronitrile), 2,2′-azobis(2-methylbutyronitrile), 2,2′-azobis(4-methoxy-2,4-dimethylvaleronitrile), and 2,2′-azobis(2,4-dimethylvaleronitrile); organic peroxide-based polymerization initiators such as benzoyl peroxide, di-tert-butyl peroxide, tert-butyl peroxyisopropylcarbonate, tert-hexyl peroxybenzoate, and tert-butyl peroxybenzoate; inorganic peroxide-based polymerization initiators such as potassium persulfate and ammonium persulfate; and redox initiators such as a hydrogen peroxide-ferrous system, a benzoyl peroxide-dimethylaniline system, and a cerium(IV) salt-alcohol system. Examples of the photopolymerization initiators include benzophenones, benzoin ethers, acetophenones, and thioxanthones. Those radical polymerization initiators may be used in combination of two or more kinds thereof.

The usage of the polymerization initiator to be used in this case is preferably regulated so as to provide a copolymer having a molecular weight distribution of interest, within the range of 0.1 to 20 parts by weight with respect to 100 parts by weight of monomers.

The polymer moiety represented by P₁ may also be produced by employing any method such as solution polymerization, suspension polymerization, emulsion polymerization, dispersion polymerization, precipitation polymerization, and bulk polymerization, and the method is not particularly limited. However, solution polymerization in a solvent capable of dissolving each component to be used at the time of production is preferred. Examples of the solvent include polar organic solvents including alcohols such as methanol, ethanol, and 2-propanol, ketones such as acetone and methyl ethyl ketone, ethers such as tetrahydrofuran and diethyl ether, ethylene glycol monoalkyl ethers or acetates thereof, propylene glycol monoalkyl ethers or acetates thereof, and diethylene glycol monoalkyl ethers, and in some cases, non-polar solvents such as toluene and xylene. Those solvents may be used alone or as a mixture thereof. Of those, solvents each having a boiling point in the temperature range of 100 to 180° C. are more preferably used alone or as a mixture thereof.

The polymerization temperature is not particularly limited, although its preferred range varies depending on the kind of initiator to be used. Specifically, polymerization is generally performed in the temperature range of −30 to 200° C., and a more preferred temperature range is the case where the temperature range is 40 to 180° C.

The molecular weight distribution and molecular structure of the polymer moiety represented by P₁ may be controlled through use of a known method. For example, a polymer moiety having a controlled molecular weight distribution and molecule structure may be produced by employing any of: a method involving utilizing an addition fragmentation type chain transfer agent (see Japanese Patent No. 4254292 and Japanese Patent No. 3721617); an NMP method involving utilizing dissociation and bonding of amine oxide radicals (e.g., Craig J. Hawker and two others, “Chemical Reviews,” (USA), American Chemical Society, 2001, 101, 3661-3688); an ATRP method involving polymerization using a halogen compound as a polymerization initiator, a heavy metal, and a ligand (e.g., Masami Kamigaito and two others, “Chemical Reviews,” (USA), American Chemical Society, 2001, 101, 3689-3746); an RAFT method using a dithiocarboxylic acid ester, a xanthate compound, or the like as a polymerization initiator (e.g., Japanese Patent Translation Publication No. 2000-515181); an MADIX method (e.g., International Patent WO99/05099A); a DT method (e.g., Atsushi Goto and six others, “Journal of The American Chemical Society,” (USA), American Chemical Society, 2003, 125, 8720-8721); and the like.

Next, Step 2 is described. In Step 2, a known method may be utilized. For example, the compound having an azo skeleton structure in which the linking group has a carboxylic acid ester bond may be synthesized through use of the polymer moiety P₁ having a carboxyl group and the azo compound (9) where Q₁ represents a substituent group having a hydroxyl group. In addition, the compound having an azo skeleton structure in which the linking group has a sulfonic acid ester bond may be synthesized through use of the polymer moiety P₁ having a hydroxyl group and the azo compound (9) where Q₁ represents a substituent group having a sulfonic acid group. Further, the compound having an azo skeleton structure in which the linking group has a carboxylic acid amide bond may be synthesized through use of the polymer moiety P₁ having a carboxyl group and the azo compound (9) where Q₁ represents a substituent group having an amino group. Specific examples thereof include a method involving using a dehydration-condensation agent such as 1-ethyl-3-(3-dimethylaminopropyl)carbodiimide hydrochloride (for example, Melvin S, Newman and one other, “The Journal of Organic Chemistry,” (USA), American Chemical Society, 1961, 26(7), 2525-2528), and a Schotten-Baumann method (for example, Norman 0. V. Sonntag, “Chemical Reviews,” (USA), American Chemical Society, 1953, 52 (2), 237-416).

This step may be performed without using any solvent, but is preferably performed in the presence of a solvent in order to prevent the reaction from proceeding abruptly. The solvent is not particularly limited as long as it does not inhibit the reaction. Examples thereof include: ethers such as diethylether, tetrahydrofuran, and dioxane; hydrocarbons such as benzene, toluene, xylene, hexane, and heptane; halogen-containing hydrocarbons such as dichloromethane, dichloroethane, and chloroform; amides such as N,N-dimethylformamide, N-methylpyrrolidone, and N,N-dimethylimidazolidinone; and nitriles such as acetonitrile and propionitrile. In addition, depending on the solubility of a solute, the solvents may be used as a mixture of two or more kinds thereof, and a mixing ratio upon the mixed use may be set to any ratio. The usage of the solvent may be set to any usage, but preferably falls within the range of 1.0 to 20 times by weight with respect to the polymer moiety represented by P₁ from the viewpoint of a reaction rate.

This step is generally performed in the temperature range of 0° C. to 250° C., and is generally completed within 24 hours.

Next, the method (ii) is described in detail by showing an example of its scheme below.

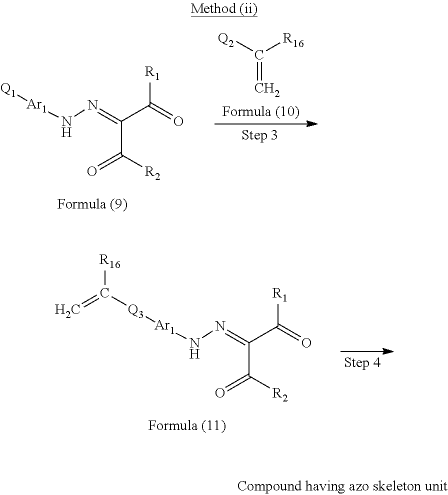

[R₁, R₂, Ar₁, and Q₁ in the formula (9) have the same meanings as R₁, R₂, Ar₁, and Q₁ in the formula (9) in the scheme of the method (i), respectively. Q₂ in the formula (10) represents a substituent group which reacts with Q₁ in the formula (9) to form Q₃ in the formula (11). R₁₆ in the formulae (10) and (11) represents a hydrogen atom or an alkyl group, and Q₃ represents a substituent group which is formed through a reaction between Q₁ in the formula (9) and Q₂ in the formula (10) and forms a divalent linking group L.]

In the method (ii) shown as an example in the foregoing, the compound having an azo skeleton structure may be synthesized by: Step 3 of subjecting the azo compound represented by the formula (9) to a reaction with a vinyl group-containing compound represented by the formula (10) to synthesize an azo compound (II) having a polymerizable functional group; and Step 4 of copolymerizing the azo compound (II) having a polymerizable functional group and a polymerizable monomer for forming the monomer unit represented by the formula (2).

First, Step 3 is described. In Step 3, the azo compound (II) having a polymerizable functional group may be synthesized by utilizing the same method as in Step 2 in the method (i). For example, the azo compound (II) having a polymerizable functional group in which the linking group is a carboxylic acid ester bond may be synthesized through use of the vinyl group-containing compound (10) having a carboxyl group and the azo compound (9) where Q₃ represents a substituent group having a hydroxyl group. In addition, the azo compound (II) having a polymerizable functional group in which the linking group is a sulfonic acid ester bond may be synthesized through use of the vinyl group-containing compound (10) having a hydroxyl group and the azo compound (9) where Q₃ represents a substituent group having a sulfonic acid group. Further, the azo compound (II) having a polymerizable functional group in which the linking group is a carboxylic acid amide bond may be synthesized through use of the vinyl group-containing compound (10) having a carboxyl group and the azo compound (9) where Q₃ represents a substituent group having an amino group.

Many kinds of commercially available products of the vinyl group-containing compound (10) are easily available. Further, the compound may be easily synthesized by a known method.

Next, Step 4 is described. In Step 4, a compound having the azo skeleton structure represented by the formula (1) may be synthesized by copolymerizing the azo compound (II) having a polymerizable functional group and a polymerizable monomer for forming the monomer unit represented by the formula (2). The same method as in the synthesis of the polymer moiety P₁ in the method (i) may be utilized as the synthesis method of Step 4.

Next, the method (iii) is described in detail by showing an example of its scheme below.

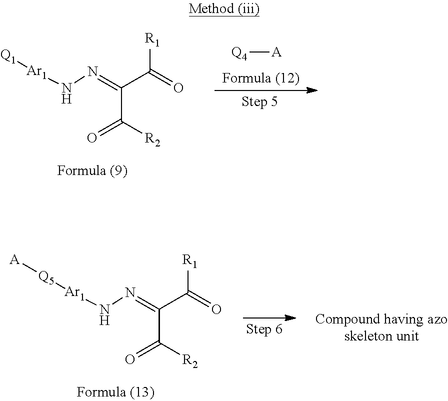

[R₁, R₂, Ar₁, and Q₁ in the formula (9) have the same meanings as R₁, R₂, Ar₁, and Q₁ in the formula (9) in the scheme of the method (i), respectively. Q₄ in the formula (12) represents a substituent group which reacts with Q₁ in the formula (9) to form Q₅ in the formula (13). A represents a chlorine atom, a bromine atom, or an iodine atom. R₁, R₂, and Ar₁ in the formula (13) have the same meanings as R₁, R₂, and Ar₁ in the formula (9), respectively, and Q₅ represents a linking group which is formed through a reaction between Q₁ in the formula (9) and Q₄ in the formula (12).]

In the method (iii) shown as an example in the foregoing, the compound having an azo skeleton structure may be synthesized by: Step 5 of subjecting the azo compound represented by the formula (9) to a reaction with a halogen atom-containing compound represented by the formula (12) to synthesize an azo compound (13) having a halogen atom; and Step 6 of polymerizing the azo compound (13) having a halogen atom as a polymerization initiator and a polymerizable monomer for forming the monomer unit represented by the formula (2).

First, Step 5 is described. In Step 5, the azo compound (13) having a halogen atom may be synthesized by utilizing the same method as in Step 2 in the method (i). For example, the azo compound (13) having a halogen atom may be synthesized through use of the halogen atom-containing compound (12) having a carboxyl group and the azo compound (9) where Q₁ represents a substituent group having a hydroxyl group. In addition, the azo compound (13) having a halogen atom may be synthesized through use of the halogen atom-containing compound (12) having a hydroxyl group and the azo compound (9) where Q₁ represents a substituent group having a sulfonic acid group. Further, the azo compound (13) having a halogen atom may be synthesized through use of the halogen atom-containing compound (12) having a carboxyl group and the azo compound (9) where Q₁ represents a substituent group having an amino group.

Examples of the halogen atom-containing compound (12) having a carboxyl group include chloroacetic acid, α-chloropropionic acid, α-chlorobutyric acid, α-chloroisobutyric acid, α-chlorovaleric acid, α-chloroisovaleric acid, α-chlorocaproic acid, α-chlorophenylacetic acid, α-chlorodiphenylacetic acid, α-chloro-α-phenylpropionic acid, α-chloro-β-phenylpropionic acid, bromoacetic acid, α-bromopropionic acid, α-bromobutyric acid, α-bromoisobutyric acid, α-bromovaleric acid, α-bromoisovaleric acid, α-bromocaproic acid, α-bromophenylacetic acid, α-bromodiphenylacetic acid, α-bromo-α-phenylpropionic acid, α-bromo-β-phenylpropionic acid, iodoacetic acid, α-iodopropionic acid, α-iodobutyric acid, α-iodoisobutyric acid, α-iodovaleric acid, α-iodoisovaleric acid, α-iodocaproic acid, α-iodophenylacetic acid, α-iododiphenylacetic acid, α-iodo-α-phenylpropionic acid, α-iodo-β-phenylpropionic acid, β-chlorobutyric acid, β-bromoisobutyric acid, iododimethylmethylbenzoic acid, and 1-chloroethylbenzoic acid. Acid halides thereof and acid anhydrides thereof may also be used in the present invention.

Examples of the halogen atom-containing compound (12) having a hydroxyl group include 1-chloroethanol, 1-bromoethanol, 1-iodoethanol, 1-chloropropanol, 2-bromopropanol, 2-chloro-2-propanol, 2-bromo-2-methylpropanol, 2-phenyl-1-bromoethanol, and 2-phenyl-2-iodoethanol.

Next, Step 6 is described. In Step 6, through utilization of the ATRP method in the method (i), the compound having an azo skeleton structure may be synthesized by polymerizing the azo compound (13) having a halogen atom as a polymerization initiator and a polymerizable monomer for forming the monomer unit (2) in the presence of a metal catalyst and a ligand.

The metal catalyst to be used in the ATRP method is not particularly limited, but is suitably at least one kind of transition metal selected from Groups 7 to 11 of the periodic table. Specifically, as a low valent metal to be used in a redox catalyst (redox conjugated complex) which is capable of undergoing reversible conversion between a low valent complex and a high valent complex, there is given a metal selected from the group consisting of Cu⁺, Ni⁰, Ni⁺, Ni²⁺, Pd⁰, Pd⁺, Pt⁰, Pt⁺, Pt²⁺, Rh⁺, Rh²⁺, Rh³⁺, Co⁺, Co²⁺, Ir⁰, Ir⁺, Ir²⁺, Ir³⁺, Fe²⁺, Ru²⁺, Ru³⁺, Ru⁴⁺, Ru⁵⁺, Os²⁺, Os³⁺, Re²⁺, Re³⁺, Re⁴⁺, Re⁶⁺, Mn²⁺, and Mn³⁺. Of those, preferred are Cu⁺, Ru²⁺, Fe²⁺, and Ni²⁺, and from the viewpoint of ease of availability, Cu⁺ is particularly preferred. A monovalent copper compound which may be suitably used is specifically exemplified by cuprous chloride, cuprous bromide, cuprous iodide, and cuprous cyanide.

As the ligand to be used in the ATRP method, an organic ligand is generally used. Examples thereof include 2,2′-bipyridyl and derivatives thereof, 1,10-phenanthroline and derivatives thereof, tetramethylethylenediamine, N,N,N′,N″,N″-pentamethyldiethylenetriamine, tris(dimethylaminoethyl)amine, triphenylphosphine, and tributylphosphine. In particular, aliphatic polyamines such as N,N,N′,N″,N″-pentamethyldiethylenetriamine are preferred in consideration of the ease of production.

In addition, when R₂ in the formula (1) represents an NR₆R₇ group, where R₆ represents a hydrogen atom and R₇ represents a phenyl group, the compound having an azo skeleton structure may be synthesized by, for example, the following method (iv).

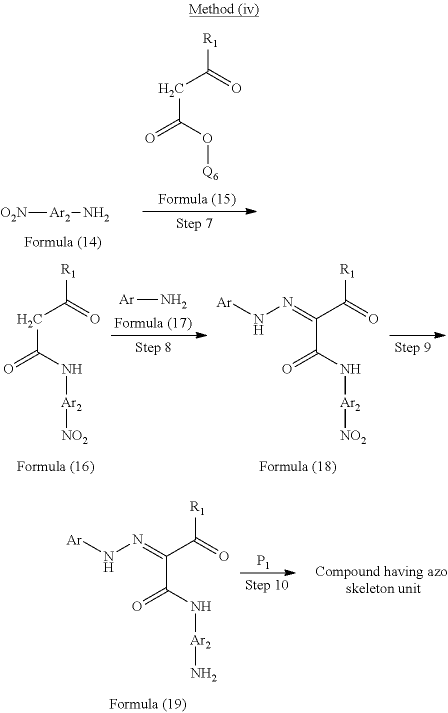

[Ar₂ in the formulae (14), (16), (18), and (19) represents an arylene group. R₁ in the formulae (15), (16), (18), and (19) has the same meaning as R₁ in the formula (1). Q₆ in the formula (15) represents a substituent group which is eliminated in a reaction with an amino group in the formula (14) to form an amide group in the formula (16). P₁ has the same meaning as P₁ in the scheme of the method (i).]

In the method (iv) shown as an example in the foregoing, the compound having an azo skeleton structure may be synthesized by: Step 7 of subjecting an aniline derivative represented by the formula (14) and a compound (15) to amidation to yield a compound (16); Step 8 of subjecting the compound (16) and an aniline analogue represented by the formula (17) as diazo components to coupling to yield an azo compound represented by the formula (18); Step 9 of reducing a nitro group into an amino group in the azo compound represented by the formula (18) with a reducing agent to yield an azo compound represented by the formula (19); and Step 10 of bonding the amino group of the azo compound represented by the formula (19) to a carboxyl group of the separately synthesized polymer moiety represented by P₁ through amidation.

First, Step 7 is described. In Step 7, a known method may be utilized (e.g., “Journal of Organic Chemistry,” 1998, 63(4), 1058-1063). Further, when R₁ in the compound (16) represents a methyl group, synthesis may also be performed by a method involving using diketene in place of the compound (15) (e.g., “Journal of Organic Chemistry,” 2007, 72(25), 9761-9764). Many kinds of commercially available products of the compound (15) are easily available. Further, the compound may be easily synthesized by a known method.

This step may be performed without using any solvent, but is preferably performed in the presence of a solvent in order to prevent the reaction from proceeding abruptly. The solvent is not particularly limited as long as it does not inhibit the reaction, and for example, a solvent having a high boiling point such as toluene or xylene may be used.

Next, Step 8 is described. In Step 8, the azo compound (18) may be synthesized by utilizing the same method as in Step 1 in the method (i).

Next, Step 9 is described. In Step 9, a nitro group has only to be subjected to a reduction reaction by, for example, a method given below. First, the azo compound (18) is dissolved in a solvent such as an alcohol, and the nitro group of the azo compound (18) is reduced to an amino group in the presence of a reducing agent at normal temperature or under a heating condition, to thereby yield the azo compound (19). The reducing agent is not particularly limited and examples thereof include sodium sulfide, sodium hydrogen sulfide, sodium hydrosulfide, sodium polysulfide, iron, zinc, tin, SnCl₂, and SnCl₂.2H₂O. The reduction reaction also proceeds in the case of employing a method involving bringing a hydrogen gas into contact with the compound in the presence of a catalyst in which a metal such as nickel, platinum, or palladium is carried by an insoluble carrier such as active carbon.

Next, Step 10 is described. In Step 10, through utilization of the same method as in Step 2 in the method (i), the compound having an azo skeleton structure may be synthesized by bonding the amino group of the azo compound represented by the formula (19) to a carboxyl group of the polymer moiety represented by P₁ through amidation.

The compound yielded in each of the steps in the synthesis method shown as an example in the foregoing may be purified through use of a general isolation/purification method for an organic compound. Examples of the isolation/purification method include a recrystallization method or reprecipitation method involving using an organic solvent, and column chromatography using silica gel or the like. A high-purity compound may be obtained by employing any one of those methods alone or employing two or more thereof in combination in performing the purification.

Next, a binding resin for the toner of the present invention is described.

Examples of the binding resin for the toner of the present invention include a styrene-methacrylic acid copolymer, a styrene-acrylic acid copolymer, a polyester resin, an epoxy resin, and a styrene-butadiene copolymer, which are generally used. In a method of directly obtaining toner particles by a polymerization method, a monomer for forming the particles is used. Specifically, there are preferably used: styrene-based monomers such as styrene, α-methylstyrene, α-ethylstyrene, o-methylstyrene, m-methylstyrene, p-methylstyrene, o-ethylstyrene, m-ethylstyrene, and p-ethylstyrene; methacrylate-based monomers such as methyl methacrylate, ethyl methacrylate, propyl methacrylate, butyl methacrylate, octyl methacrylate, dodecyl methacrylate, stearyl methacrylate, behenyl methacrylate, 2-ethylhexyl methacrylate, dimethylaminoethyl methacrylate, diethylaminoethyl methacrylate, methacrylonitrile, and methacrylamide; acrylate-based monomers such as methyl acrylate, ethyl acrylate, propyl acrylate, butyl acrylate, octyl acrylate, dodecyl acrylate, stearyl acrylate, behenyl acrylate, 2-ethylhexyl acrylate, dimethylaminoethyl acrylate, diethylaminoethyl acrylate, acrylonitrile, and acrylamide; and olefin-based monomers such as butadiene, isoprene, and cyclohexene. Those monomers are used alone, or as an appropriate mixture thereof that exhibits a theoretical glass transition temperature (Tg) in the range of 40 to 75° C. (see J. Brandrup, E. H. Immergut (ed.), “Polymer Handbook,” (USA), 3rd edition, John Wiley & Sons, 1989, p. 209-277). When the theoretical glass transition temperature is less than 40° C., problems are liable to arise from the viewpoints of storage stability and durability stability of toner. On the other hand, when the theoretical glass transition temperature is more than 75° C., a reduction in transparency occurs when a full-color image of the toner is formed. In the binding resin in the toner of the present invention, the use of a non-polar resin such as polystyrene in combination with a polar resin such as a polyester resin or a polycarbonate resin can control the distribution of an additive such as a coloring agent, a charge controlling agent, or a wax in the toner. For example, when the toner particles are directly produced by a suspension polymerization method or the like, the polar resin is added in a polymerization reaction commencing on a dispersing step and ending on a polymerizing step. The polar resin is added according to a balance between the polarities of an aqueous medium and a monomer unit composition to serve as the toner particles. As a result, for example, a thin layer of the polar resin is formed on the surface of the toner particles, and the concentration of the resin may be controlled so as to continuously change from the surface of the toner particles toward the center. At this time, the use of the polar resin having interactions with the compound having an azo skeleton structure, the coloring agent, and the charge controlling agent allows the coloring agent to be present in a desired state in the toner particles.

Carbon black to be used as the coloring agent for the toner of the present invention is not particularly limited, and for example, there may be used carbon black obtained by a production method such as a thermal method, an acetylene method, a channel method, a furnace method, or a lamp black method.

The average primary particle diameter of the carbon black to be used in the present invention is not particularly limited, but is an average primary particle diameter of preferably 14 to 80 nm, more preferably 25 to 50 nm. When the average primary particle diameter is less than 14 nm, the toner has a reddish hue, and is unsuitable as black for full-color image formation. In contrast, the case where the average primary particle diameter of the carbon black is more than 80 nm is not preferred because the coloring power becomes excessively low even when the dispersibility is satisfactory.

It should be noted that the average primary particle diameter of the carbon black may be measured by taking an enlarged photograph with a scanning electron microscope.

The DBP oil absorption of the carbon black to be used in the present invention is not particularly limited, and is preferably 30 to 200 ml/100 g, more preferably 40 to 150 ml/100 g. When the DBP oil absorption of the carbon black is less than 30 ml/100 g, the coloring power is liable to lower even when the dispersibility is satisfactory. In contrast, the case where the DBP oil absorption of the carbon black is more than 200 ml/100 g is not preferred because a large amount of a solvent is required for producing a pigment composition in a toner production process.

It should be noted that the DBP oil absorption of the carbon black refers to an amount of dibutyl phthalate (DBP) to be absorbed by 100 g of carbon black, and may be measured in conformity with “JIS K6217.”

The pH of the carbon black to be used in the present invention is not particularly limited as long as the effect of the compound having an azo skeleton structure is not significantly inhibited and toner characteristics such as toner fixability and fogging suppression are not inhibited.

It should be noted that the pH of the carbon black may be determined by subjecting a mixed liquid of the carbon black and distilled water to measurement with a pH electrode.

The specific surface area of the carbon black to be used in the present invention is not particularly limited, and is preferably 300 m²/g or less, more preferably 100 m²/g or less. The case where the specific surface area of the carbon black is more than 300 m²/g is not preferred because the compound having an azo skeleton structure, which is required for obtaining the satisfactory dispersibility of the carbon black, is required in a large amount.

It should be noted that the specific surface area of the carbon black refers to a BET specific surface area, and may be measured in conformity with “JIS K4652.”

One kind of the carbon black may be used alone, or two or more kinds thereof may be used as a mixture.

The carbon black may be a crude pigment, or may be a prepared pigment composition as long as the effect of the compound having an azo skeleton structure is not significantly inhibited.

The case where a weight composition ratio between the carbon black and the compound having an azo skeleton structure in the toner of the present invention falls within the range of 100:0.1 to 100:100 is preferred, and the case where the ratio falls within the range of 100:0.5 to 100:20 is more preferred from the viewpoint of pigment dispersibility when the specific surface area of the carbon black is 30 to 200 m²/g.

The carbon black is always used as the coloring agent in the toner of the present invention, but another coloring agent may be used in combination with the carbon black for the purpose of adjusting a color tone as long as the dispersibility of the carbon black is not inhibited.

As the coloring agent which may be used in combination with the carbon black, when the toner is used as a non-magnetic toner, a known black coloring agent may be used.

Examples of the black coloring agent which may be used in combination with the carbon black include C.I. Pigment Black 1, C.I. Pigment Black 10, C.I. Pigment Black 31, C.I. Natural Black 1, C.I. Natural Black 2, C.I. Natural Black 3, C.I. Natural Black 4, C.I. Natural Black 5, C.I. Natural Black 6, and activated carbon.

Further, when the toner of the present invention is used as a magnetic toner, a magnetic material given below may be used as the black coloring agent. That is, for example, there are given iron oxides such as magnetite, maghemite, and ferrite or iron oxides containing other metal oxides, metals such as Fe, Co, and Ni or alloys of these metals and metals such as Al, Co, Cu, Pb, Mg, Ni, Sn, Zn, Sb, Be, Bi, Cd, Ca, Mn, Se, Ti, W, and V, and mixtures thereof.

The usage of any such coloring agent varies depending on the kind of the coloring agent. It is suitable that the total usage be 0.1 to 60 parts by weight, preferably 0.5 to 50 parts by weight, with respect to 100 parts by weight of the binding resin.

Further, in the toner of the present invention, a known magenta coloring agent, cyan coloring agent, or yellow coloring agent may be used in combination for the purpose of adjusting a color tone.

Further, in the present invention, a crosslinking agent may be used at the time of the synthesis of the binding resin for improving the mechanical strength of the toner particles, and at the same time, for controlling the molecular weight of a molecule constituting the particles.

Examples of the crosslinking agent to be used in the toner particle of the present invention include: bifunctional crosslinking agents such as divinylbenzene, bis(4-acryloxypolyethoxyphenyl)propane, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, diacrylates of polyethylene glycols #200, #400, and #600, dipropylene glycol diacrylate, polypropylene glycol diacrylate, polyester-type diacrylates, and ones obtained by changing these diacrylates to dimethacrylates; and

polyfunctional crosslinking agents such as pentaerythritol triacrylate, trimethylolethane triacrylate, trimethylolpropane triacrylate, tetramethylolmethane tetraacrylate, oligoester acrylate and methacrylate thereof, 2,2-bis(4-methacryloxyphenyl)propane, diallyl phthalate, triallyl cyanurate, triallyl isocyanurate, and triallyl trimellitate.

It is recommended that any such crosslinking agent be used in preferably the range of 0.05 to 10 parts by mass, more preferably the range of 0.1 to 5 parts by mass, with respect to 100 parts by mass of the monomer, from the viewpoint of toner fixability and offset resistance.

Further, in the present invention, a wax component may be used at the time of the synthesis of the binding resin in order to prevent the toner from adhering to a fixing member.

Examples of the wax component which may be used in the present invention include: petroleum-based wax and derivatives thereof such as paraffin wax, microcrystalline wax, and petrolatum; montan wax and derivatives thereof; hydrocarbon wax and derivatives thereof by a Fischer-Tropsch process; polyolefin wax and derivatives thereof typified by polyethylene; and natural wax and derivatives thereof such as carnauba wax and candelilla wax. The derivatives include an oxide, a block copolymer with a vinyl monomer, and a graft modified product. Further examples include: alcohols such as higher aliphatic alcohols; fatty acids such as stearic acid and palmitic acid; fatty acid amides; fatty acid esters; hydrogenated castor oil and derivatives thereof; plant wax; and animal wax. One kind of those wax components may be used alone, or two or more kinds thereof may be used in combination.

With regard to the addition amount of the wax component, the total content falls within the range of preferably 2.5 to 15.0 parts by mass, more preferably 3.0 to 10.0 parts by mass, with respect to 100 parts by mass of the binding resin. When the addition amount of the wax component is less than 2.5 parts by mass, oilless fixation becomes difficult. When the addition amount is more than 15.0 parts by mass, the amount of the wax component in the toner particles is excessively large, and hence an excessive wax component is present in a large amount on the surface of the toner particles, which may inhibit a desired charging characteristic. Thus, both the cases are not preferred.

In the toner of the present invention, a charge controlling agent may also be mixed, as necessary. This allows the control of an optimal triboelectric charging amount depending on a development system.

As the charge controlling agent, a known one may be utilized, and a charge controlling agent which has a high charging speed and can stably maintain a certain charging amount is particularly preferred. In addition, when the toner particles are produced by a direct polymerization method, a charge controlling agent which has low polymerization inhibition property and is substantially free of any substance soluble in an aqueous dispersion medium is particularly preferred.

The charge controlling agent is exemplified by charge controlling agents for controlling the toner so as to have a negative charge, such as a polymer or copolymer having a sulfonic acid group, a sulfonic acid salt group, or a sulfonic acid ester group, a salicylic acid derivative and a metal complex thereof, a monoazo metal compound, an acetylacetone metal compound, an aromatic oxycarboxylic acid, aromatic mono- and polycarboxylic acids and metal salts, anhydrides, and esters thereof, phenol derivatives such as bisphenol, a urea derivative, a metal-containing naphthoic acid-based compound, a boron compound, a quaternary ammonium salt, a calixarene, and a resin-based charge controlling agent. The charge controlling agent is also exemplified by charge controlling agents for controlling the toner so as to have a positive charge, such as: nigrosine-modified products with nigrosine, fatty acid metal salts, and the like; guanidine compounds; imidazole compounds; quaternary ammonium salts such as tributylbenzylammonium-1-hydroxy-4-naphthosulfonate and tetrabutylammonium tetrafluoroborate, and analogues thereof including onium salts such as phosphonium salts and lake pigments thereof; triphenylmethane dyes and lake pigments thereof (laking agents include phosphotungstic acid, phosphomolybdic acid, phosphotungstic molybdic acid, tannic acid, lauric acid, gallic acid, ferricyanides, and ferrocyanides); metal salts of higher fatty acids; diorganotin oxides such as dibutyl tin oxide, dioctyl tin oxide, and dicyclohexyl tin oxide; diorganotin borates such as dibutyl tin borate, dioctyl tin borate, and dicyclohexyl tin borate; and a resin-based charge controlling agent. One kind of those charge controlling agents may be used alone, or two or more kinds thereof may be used in combination.

In the toner of the present invention, inorganic fine powder may be added as a fluidizing agent to the toner particles. Fine powder of, for example, silica, titanium oxide, alumina, or a complex oxide thereof, or a product obtained by treating the surface of any such oxide may be used as the inorganic fine powder.

A method of producing the toner particles that form the toner of the present invention is, for example, a conventionally used method such as a pulverization method, a suspension polymerization method, a suspension granulation method, or an emulsion polymerization method. The toner particles are particularly preferably obtained by, of those production methods, a production method involving granulation in an aqueous medium such as the suspension polymerization method or the suspension granulation method from the viewpoints of an environmental load at the time of the production and the controllability of a particle diameter.

In the method of producing the toner of the present invention, the dispersibility of carbon black may be improved by mixing the compound having an azo skeleton structure and the carbon black in advance to prepare a pigment composition.

The pigment composition may be produced by a wet or dry process. The pigment composition is preferably produced by the wet process, which can produce a homogeneous pigment composition in a simple manner, in consideration of the fact that the compound having an azo skeleton structure has a high affinity for a water-insoluble solvent. For example, the pigment composition is obtained as described below. The compound having an azo skeleton structure, and as necessary, a resin are dissolved in a dispersion medium, and then pigment powder is gradually added so as to be sufficiently mixed with the dispersion medium while the solution is stirred. Further, a mechanical shear force is applied to the resultant with a dispersing machine such as a kneader, a roll mill, a ball mill, a paint shaker, a dissolver, an attritor, a sand mill, or a high-speed mill so that carbon black may be finely dispersed in a stably uniform fine particulate fashion.

The dispersion medium which may be used in the pigment composition is not particularly limited. However, the case where the dispersion medium is a water-insoluble solvent is preferred in order to obtain a high dispersing effect of the compound having an azo skeleton structure on the pigment. Examples of the water-insoluble solvent include: esters such as methyl acetate, ethyl acetate, and propyl acetate; hydrocarbons such as hexane, octane, petroleum ether, cyclohexane, benzene, toluene, and xylene; and halogen-containing hydrocarbons such as carbon tetrachloride, trichloroethylene, and tetrabromoethane.

The dispersion medium which may be used for the pigment composition may be a polymerizable monomer. Specific examples thereof may include styrene, α-methylstyrene, α-ethylstyrene, o-methylstyrene, m-methylstyrene, p-methylstyrene, p-methoxystyrene, p-phenylstyrene, p-chlorostyrene, 3,4-dichlorostyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, ethylene, propylene, butylene, isobutylene, vinyl chloride, vinylidene chloride, vinyl bromide, vinyl iodide, vinyl acetate, vinyl propionate, vinyl benzoate, methacrylic acid, methyl methacrylate, ethyl methacrylate, propyl methacrylate, butyl methacrylate, n-octyl methacrylate, dodecyl methacrylate, 2-ethylhexyl methacrylate, stearyl methacrylate, behenyl methacrylate, phenyl methacrylate, dimethylaminoethyl methacrylate, diethylaminoethyl methacrylate, acrylic acid, methyl acrylate, ethyl acrylate, n-butyl acrylate, isobutyl acrylate, propyl acrylate, n-octyl acrylate, dodecyl acrylate, 2-ethylhexyl acrylate, stearyl acrylate, behenyl acrylate, 2-chloroethyl acrylate, phenyl acrylate, vinyl methyl ether, vinyl ethyl ether, vinyl isobutyl ether, vinyl methyl ketone, vinyl hexyl ketone, methyl isopropenyl ketone, vinylnaphthalene, acrylonitrile, methacrylonitrile, and acrylamide.

As a resin which may be used in the pigment composition, there may be used a resin which may be used as a binding resin for the toner of the present invention. Examples thereof include a styrene-methacrylic acid copolymer, a styrene-acrylic acid copolymer, a polyester resin, an epoxy resin, and a styrene-butadiene copolymer. In addition, two or more kinds of those dispersion media may be used as a mixture.

Further, the pigment composition may be isolated by a known method such as filtration, decantation, or centrifugation. The solvent may be removed by washing.

An auxiliary may be further added to the pigment composition at the time of its production. Examples of the auxiliary include surface-active agents, dispersants, fillers, standardizers, resins, waxes, defoaming agents, antistatic agents, dust-proof agents, bulking agents, shading coloring agents (shading colorants), preservatives, drying inhibitors, rheology control additives, wetting agents, antioxidants, UV absorbers, light stabilizers, and combinations thereof. In addition, the compound having an azo skeleton structure may be added in advance upon production of a crude pigment.

The toner particles of the present invention to be produced by the suspension polymerization method are produced, for example, as described below. The pigment composition, the polymerizable monomer, the wax component, the polymerization initiator, and the like are mixed to prepare a polymerizable monomer composition. Next, the polymerizable monomer composition is dispersed in an aqueous medium, and the polymerizable monomer composition is granulated into particles. Then, in the aqueous medium, the polymerizable monomer in each of the particles of the polymerizable monomer composition is polymerized. Thus, the toner particles are obtained.

The polymerizable monomer composition in the above-mentioned step is preferably prepared by mixing a dispersion liquid, which is obtained by dispersing the pigment composition in a first polymerizable monomer, with a second polymerizable monomer. That is, when the pigment composition is sufficiently dispersed by the first polymerizable monomer and then the resultant is mixed with the second polymerizable monomer as well as the other toner materials, carbon black can exist in an additionally satisfactory dispersed state in each of the toner particles.

A known polymerization initiator may be given as the polymerization initiator to be used in the suspension polymerization method, and examples of the polymerization initiator include an azo compound, an organic peroxide, an inorganic peroxide, an organometallic compound, and a photopolymerization initiator. More specific examples thereof include: azo-based polymerization initiators such as 2,2′-azobis(isobutyronitrile), 2,2′-azobis(2-methylbutyronitrile), 2,2′-azobis(4-methoxy-2,4-dimethylvaleronitrile), 2,2′-azobis(2,4-dimethylvaleronitrile), and dimethyl 2,2′-azobis(isobutyrate); organic peroxide-based polymerization initiators such as benzoyl peroxide, di-tert-butyl peroxide, tert-butyl peroxyisopropylmonocarbonate, tert-hexyl peroxybenzoate, and tert-butyl peroxybenzoate; inorganic peroxide-based polymerization initiators such as potassium persulfate and ammonium persulfate; and redox initiators such as hydrogen peroxide-ferrous, BPO-dimethylaniline-based, and cerium (IV) salt-alcohol-based redox initiators. Examples of the photopolymerization initiator include acetophenones, benzoin ethers, and ketals. Those methods may be used alone or in combination of two or more thereof.

The case where the concentration of the polymerization initiator falls within the range of 0.1 to 20 parts by weight with respect to 100 parts by weight of the polymerizable monomer is preferred. The case where the concentration falls within the range of 0.1 to 10 parts by weight is more preferred. Although the kind of the polymerization initiator slightly varies depending on the polymerization method, the polymerization initiators are used alone or as a mixture of two or more thereof, with reference to a 10-hour half-life temperature.

A dispersion stabilizer is preferably incorporated into the aqueous medium to be used in the suspension polymerization method. A known inorganic dispersion stabilizer and a known organic dispersion stabilizer may be used as the dispersion stabilizer. Examples of the inorganic dispersion stabilizer include calcium phosphate, magnesium phosphate, aluminum phosphate, zinc phosphate, magnesium carbonate, calcium carbonate, calcium hydroxide, magnesium hydroxide, aluminum hydroxide, calcium metasilicate, calcium sulfate, barium sulfate, bentonite, silica, and alumina. Examples of the organic dispersion stabilizer include polyvinyl alcohol, gelatin, methylcellulose, methylhydroxypropylcellulose, ethylcellulose, a sodium salt of carboxymethylcellulose, and starch. In addition, nonionic, anionic, and cationic surfactants may also be used, and examples thereof include sodium dodecyl sulfate, sodium tetradecyl sulfate, sodium pentadecyl sulfate, sodium octyl sulfate, sodium oleate, sodium laurate, potassium stearate, and calcium oleate.

Of the dispersion stabilizers, a poorly water-soluble, inorganic dispersion stabilizer that is soluble in an acid is preferably used in the present invention. In addition, in the present invention, when an aqueous dispersion medium is prepared with the poorly water-soluble, inorganic dispersion stabilizer, such dispersion stabilizer is preferably used at a ratio in the range of 0.2 to 2.0 parts by weight with respect to 100 parts by weight of the polymerizable monomer in terms of the droplet stability of the polymerizable monomer composition in the aqueous medium. In addition, in the present invention, the aqueous medium is preferably prepared with water whose amount ranges from 300 to 3,000 parts by weight with respect to 100 parts by weight of the polymerizable monomer composition.

In the present invention, when the aqueous medium in which the poorly water-soluble, inorganic dispersion stabilizer is dispersed is prepared, a commercially available dispersion stabilizer may be directly used and dispersed, but the preparation is preferably performed by producing the poorly water-soluble, inorganic dispersion stabilizer in water under high-speed stirring in order that fine dispersion stabilizer particles having a uniform particle size may be obtained. For example, when calcium phosphate is used as a dispersion stabilizer, a preferred dispersion stabilizer can be obtained by forming calcium phosphate fine particles through the mixing of an aqueous solution of sodium phosphate and an aqueous solution of calcium chloride under high-speed stirring.

Even when the toner particles of the present invention are produced by the suspension granulation method, the toner particles to be obtained can be suitable. No heating step is included in the production steps of the suspension granulation method. Hence, the compatibilization of the resin and the wax component that occurs when a low-melting wax is used is suppressed, and a reduction in the glass transition temperature of the toner resulting from the compatibilization can be prevented. In addition, the suspension granulation method offers a wide choice of toner materials each serving as the binding resin, and facilitates the use of a polyester resin generally credited with being advantageous for fixability as a main component. Accordingly, the suspension granulation method is a production method advantageous when a toner of such resin composition that the suspension polymerization method cannot be applied is produced.

The toner particles to be produced by the suspension granulation method are produced, for example, as described below. First, the pigment composition, the binding resin, the wax component, and the like are mixed in a solvent so that a solvent composition may be prepared. Next, the solvent composition is dispersed in an aqueous medium so that the solvent composition may be granulated into particles. Thus, a toner particle suspension liquid is obtained. Then, the solvent is removed from the resultant suspension liquid by heating or decompression so that the toner particles may be obtained.

The solvent composition in the above-mentioned step is preferably a composition prepared by mixing a dispersion liquid, which is obtained by dispersing the pigment composition in a first solvent, with a second solvent. That is, carbon black can exist in an additionally satisfactory dispersed state in each of the toner particles by sufficiently dispersing the pigment composition with the first solvent and mixing the resultant with the second solvent together with any other toner material.

Examples of the solvent which may be used in the suspension granulation method include: hydrocarbons such as toluene, xylene, and hexane; halogen-containing hydrocarbons such as methylene chloride, chloroform, dichloroethane, trichloroethane, and carbon tetrachloride; alcohols such as methanol, ethanol, butanol, and isopropyl alcohol; polyhydric alcohols such as ethylene glycol, propylene glycol, diethylene glycol, and triethylene glycol; cellosolves such as methyl cellosolve and ethyl cellosolve; ketones such as acetone, methyl ethyl ketone, and methyl isobutyl ketone; ethers such as benzyl alcohol ethyl ether, benzyl alcohol isopropyl ether, and tetrahydrofuran; and esters such as methyl acetate, ethyl acetate, and butyl acetate. Those solvents may be used alone or as a mixture of two or more kinds thereof. Of those, a solvent having a low boiling point and capable of sufficiently dissolving the binding resin is preferably used in order that the solvent in the toner particle suspension liquid may be easily removed.

The case where the usage of the solvent falls within the range of 50 to 5,000 parts by weight with respect to 100 parts by weight of the binding resin is preferred. The case where the usage falls within the range of 120 to 1,000 parts by weight is more preferred.

A dispersion stabilizer is preferably incorporated into the aqueous medium to be used in the suspension granulation method. A known inorganic dispersion stabilizer and a known organic dispersion stabilizer may be used as the dispersion stabilizer. Examples of the inorganic dispersion stabilizer include calcium phosphate, calcium carbonate, aluminum hydroxide, calcium sulfate, and barium carbonate. Examples of the organic dispersion stabilizer include polyvinyl alcohol, sodium salts of methyl cellulose, hydroxyethyl cellulose, ethyl cellulose, and carboxymethyl cellulose, water-soluble polymers such as sodium polyacrylate and sodium polymethacrylate, anionic surfactants such as sodium dodecylbenzene sulfonate, sodium octadecyl sulfate, sodium oleate, sodium laurate, and potassium stearate, cationic surfactants such as lauryl amine acetate, stearyl amine acetate, and lauryl trimethylammonium chloride, zwitterionic surfactants such as lauryl dimethylamine oxide, nonionic surfactants such as polyoxyethylene alkyl ether, polyoxyethylene alkyl phenyl ether, and polyoxyethylene alkyl amine.

The case where the usage of the dispersion stabilizer falls within the range of 0.01 to 20 parts by weight with respect to 100 parts by weight of the binding resin is preferred in terms of the droplet stability of the solvent composition in the aqueous medium.

In the present invention, the case where the weight average particle diameter (hereinafter, described as “D4”) of the toner falls within the range of 3.00 to 15.0 μm is preferred. The case where the D4 of the toner falls within the range of 4.00 to 12.0 μm is more preferred. When the D4 of the toner falls within the range, charge stability is kept and an image with high-definition may be formed easily.

Further, the ratio of the D4 of the toner to the number average particle diameter (hereinafter, described as “D1”) thereof (hereinafter, described as “D4/D1”) is preferably 1.35 or less, more preferably 1.30 or less for achieving the suppression of fogging and the improvement of transfer efficiency while maintaining high resolution.

It should be noted that methods of adjusting the D4 and D1 of the toner of the present invention vary depending on a method of producing the toner particles. In the case of, for example, the suspension polymerization method, the adjustment may be performed by controlling the concentration of the dispersant used at the time of the preparation of the aqueous dispersion medium, a reaction stirring speed or a reaction stirring time, or the like.

The toner of the present invention may be a magnetic toner or may be a non-magnetic toner. When the toner of the present invention is used as a magnetic toner, the toner particles constituting the toner of the present invention may each be mixed with a magnetic material before use. Examples of the magnetic material include iron oxides such as magnetite, maghemite, and ferrite or iron oxides containing other metal oxides, metals such as Fe, Co, and Ni or alloys of those metals and metals such as Al, Co, Cu, Pb, Mg, Ni, Sn, Zn, Sb, Be, Bi, Cd, Ca, Mn, Se, Ti, W, and V, and mixtures thereof. The magnetic material that is particularly suitable for the object of the present invention is fine powder of triiron tetraoxide or γ-diiron trioxide.

The following case is preferred in terms of the developability of the toner: the average particle diameter of such magnetic material is 0.1 to 2 μm (preferably 0.1 to 0.3 μm), and the magnetic characteristics thereof under application of a magnetic field of 795.8 kA/m are a coercive force of 1.6 to 12 kA/m, a saturation magnetization of 5 to 200 Am²/kg (preferably 50 to 100 Am²/kg), and a residual magnetization of 2 to 20 Am²/kg.

The addition amount of such magnetic material with respect to 100 parts by weight of the binding resin is as follows: the magnetic material is used at 10 to 200 parts by weight, and the case where the magnetic material is used at 20 to 150 parts by weight is preferred.

### EXAMPLES

Hereinafter, the present invention is described in more detail by way of examples and comparative examples. However, the present invention is by no means limited to the following examples without departing from the gist of the present invention. It should be noted that, in the following description, unless otherwise stated, the terms “part(s)” and “%” refer to “part(s) by mass” and “mass %”, respectively.

Measurement methods to be employed in the synthesis examples are described below.

### (1) Molecular Weight Measurement (GPC)

The molecular weight of the compound having a polymer moiety and an azo skeleton structure of the present invention is calculated by size exclusion chromatography (SEC) in terms of polystyrene. The measurement of the molecular weight by SEC was performed as described below.

A sample was added to the following eluent so that a sample concentration may be 1.0%. The mixture was left at rest at room temperature for 24 hours. The resultant solution was filtered with a solvent-resistant membrane filter having a pore size of 0.2 μm. The resultant filtrate was defined as a sample solution. Then, the sample solution was subjected to measurement under the following conditions.

Apparatus: High-speed GPC apparatus
(HLC-8220GPC) (manufactured by TOSOH CORPORATION)

### Column: Twin LF-804

### Eluent: THF

Flow rate: 1.0 ml/min
Oven temperature: 40° C.
Sample injection amount: 0.025 ml

In addition, in the calculation of the molecular weight of the sample, a molecular weight calibration curve prepared with standard polystyrene resins (TSK standard polystyrenes F-850, F-450, F-288, F-128, F-80, F-40, F-20, F-10, F-4, F-2, F-1, A-5000, A-2500, A-1000, and A-500 manufactured by Tosoh Corporation) was used.

### (2) Acid Value Measurement

The acid value of the compound having a polymer moiety and an azo skeleton structure of the present invention is determined by the following method.

Basic operations are based on JIS K-0070.

(1) 0.5 to 2.0 Grams of a sample are precisely weighed. The mass at this time is represented by M (g).
(2) The sample is loaded into a 50-ml beaker, and 25 ml of a mixed liquid of tetrahydrofuran and ethanol (2/1) are added to dissolve the sample.
(3) The resultant solution is titrated with a 0.1-mol/l solution of KOH in ethanol by using a potentiometric titration measuring apparatus (for example, an automatic titration measuring apparatus COM-2500 manufactured by Hiranuma Sangyo Co., Ltd. may be utilized).
(4) The usage of the KOH solution at the time is represented by S (ml). Blank measurement is simultaneously performed, and the usage of the KOH solution at this time is represented by B (ml).
(5) The acid value is calculated from the following equation where f represents the factor of the KOH solution.

$$Acid value [ mg KOH \text{/} g ] = \frac{( S - B ) \times f \times 5.61}{W}$$

### (3) Compositional Analysis

The structures of the compound having a polymer moiety and an azo skeleton structure were determined with the following apparatus.

¹H NMR (ECA-400 manufactured by JEOL Ltd. (solvent used: deuterated chloroform))

¹³C NMR (FT-NMR AVANCE-600 manufactured by Bruker BioSpin K.K. (solvent used: deuterated chloroform))

It should be noted that, in the ¹³C NMR, compositional analysis was performed through quantification by an inverse gated decoupling method involving using chromium(III) acetylacetonate as a relaxation agent.

### Example 1

The compound having an azo skeleton structure was obtained by the following method.

### <Production Example of Compound (101)>

Compound (101) having an azo skeleton structure was produced according to the following scheme.

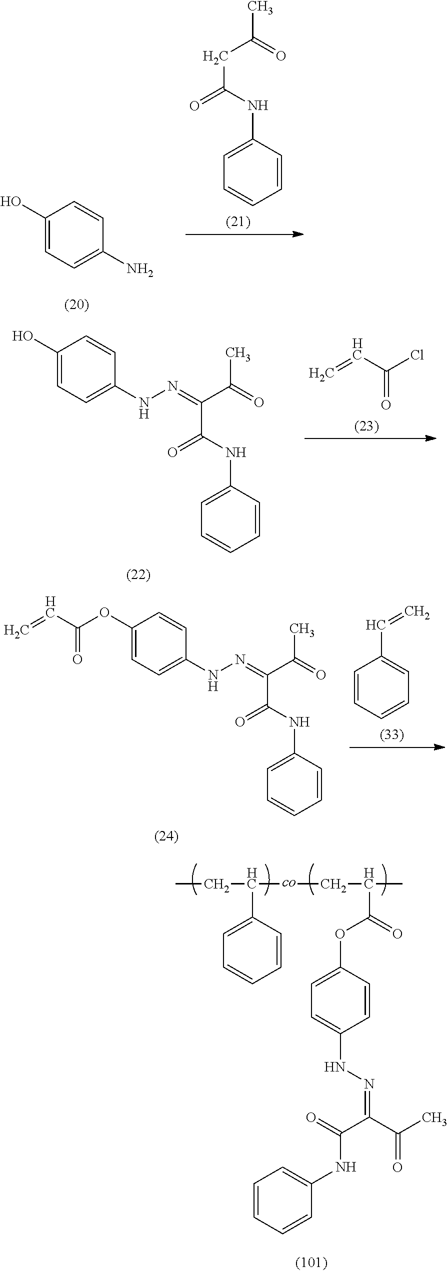

[In the scheme, “co” is a symbol for indicating that the sequence of monomer units constituting a copolymer is random.]

First, 30.0 parts of water and 11.0 parts of concentrated hydrochloric acid were added to 5.00 parts of Compound (20), and the solution was cooled with ice to 10° C. or less. To the solution was added a solution obtained by dissolving 3.46 parts of sodium nitrite in 8.10 parts of water, and the mixture was subjected to a reaction at the above-mentioned temperature for 1 hour. Next, 0.657 part of sulfamic acid was added, and the mixture was stirred for an additional 20 minutes (diazonium salt solution). 8.13 Parts of Compound (21) were added to 48.0 parts of water, the mixture was cooled with ice to 10° C. or less, and then the diazonium salt solution was added. After that, a solution obtained by dissolving 14.3 parts of sodium carbonate in 80.0 parts of water was added, and the mixture was subjected to a reaction at 10° C. or less for 2 hours. After the completion of the reaction, 50 parts of water were added, and the mixture was stirred for 30 minutes. After that, the solid was separated by filtration and purified by a recrystallization method from N,N-dimethylformamide. Thus, 13.2 parts of Compound (22) were obtained (in 98.9% yield).

Next, 3.00 parts of Compound (22) and 1.20 parts of triethylamine were added to 30.0 parts of chloroform, and the mixture was cooled with ice to 10° C. or less. To the solution were added 1.03 parts of Compound (23), and the mixture was subjected to a reaction at the above-mentioned temperature for 20 minutes. The resultant was extracted with chloroform, concentrated, and purified. Thus, 3.40 parts of Compound (24) were obtained (in 98.8% yield).

Next, 9.44 parts of N,N-dimethylformamide, 1.06 parts of Compound (24), and 0.327 part of azobisisobutyronitrile were added to 10 parts of Compound (33), and the mixture was stirred under a nitrogen atmosphere at 80° C. for 2 hours. After the completion of the reaction, the resultant was purified by a recrystallization method from N,N-dimethylformamide. Thus, 7.60 parts of Compound (101) were obtained (in 69.0% yield).

### (Results of Analysis of Compound (101) Having Azo Skeleton Structure)

[1] Results of molecular weight measurement (GPC):

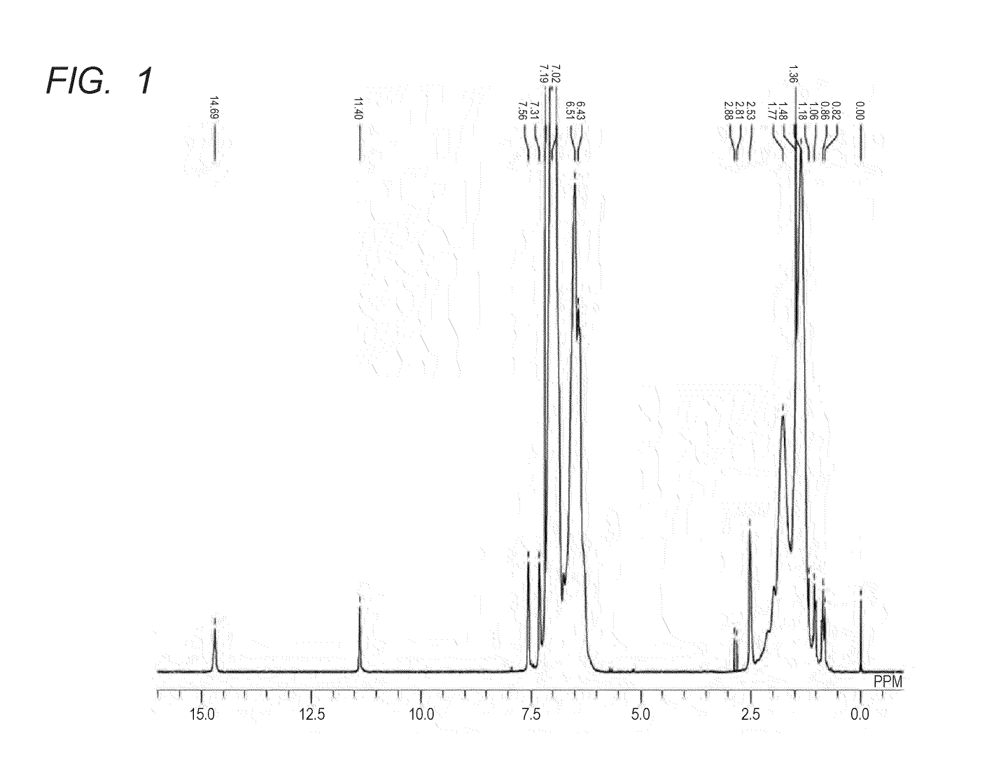

Weight average molecular weight (Mw)=16,762; number average molecular weight (Mn)=10,221

[2] Result of acid value measurement:
0 mgKOH/g
[3] Results of ¹H NMR (400 MHz, CDCl₃, room temperature) (see FIG. 1):

δ[ppm]=14.69 (s, 1H), 11.40 (s, 1H), 7.56 (s, 2H), 7.31 (s, 2H), 7.19-6.43 (m, 135H), 2.53 (s, 3H), 2.47-1.05 (m, 97H)

### <Production Example of Compound (107)>

Compound (107) having an azo skeleton structure was produced according to the following scheme.

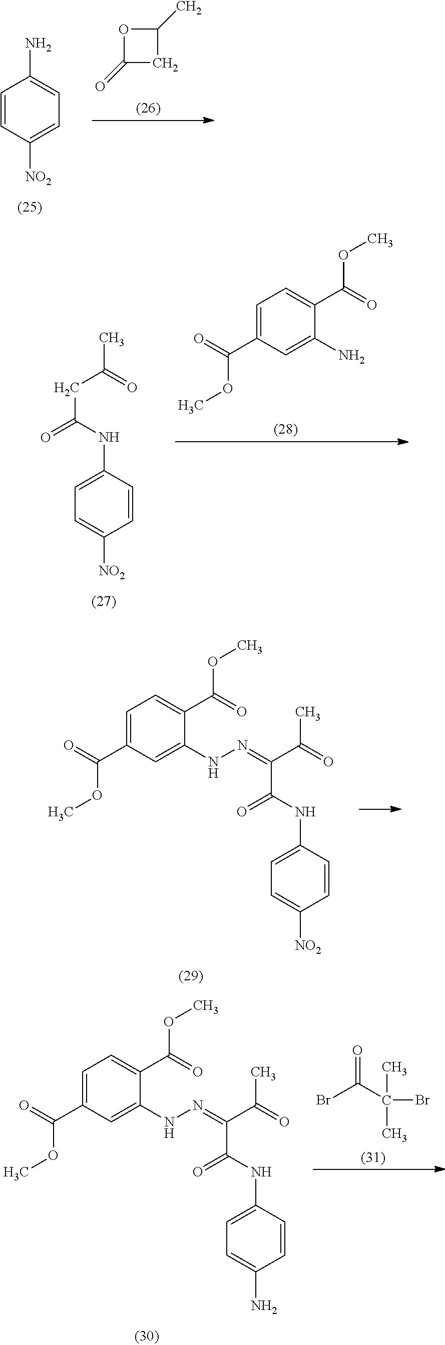

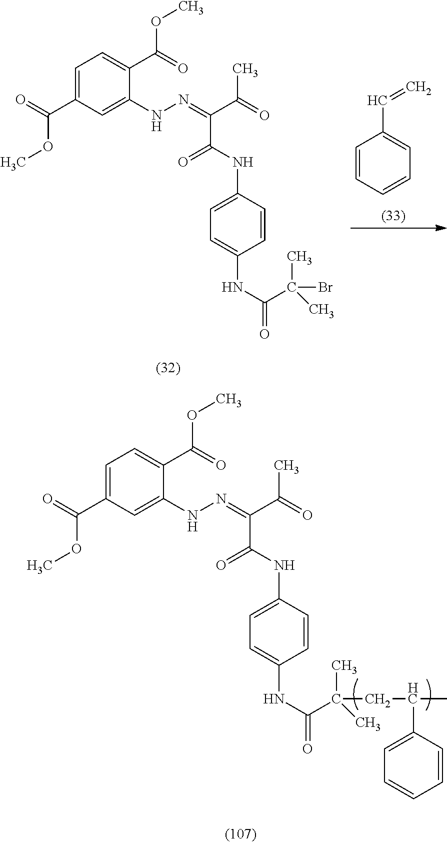

First, 3.11 parts of Compound (25) were added to 30 parts of chloroform, and the mixture was cooled with ice to 10° C. or less. To the mixture were added 1.89 parts of Compound (26). After that, the resultant was stirred at 65° C. for 2 hours. After the completion of the reaction, the resultant was extracted with chloroform and concentrated. Thus, 4.80 parts of Compound (27) were obtained (in 96.0% yield).

Next, 40.0 parts of methanol and 5.29 parts of concentrated hydrochloric acid were added to 4.25 parts of Compound (28), and the mixture was cooled with ice to 10° C. or less. To the solution was added a solution obtained by dissolving 2.10 parts of sodium nitrite in 6.00 parts of water, and the mixture was subjected to a reaction at the above-mentioned temperature for 1 hour. Next, 0.990 part of sulfamic acid was added, and the mixture was stirred for an additional 20 minutes (diazonium salt solution). 4.51 Parts of Compound (27) were added to 70.0 parts of methanol, the mixture was cooled with ice to 10° C. or less, and then the diazonium salt solution was added. After that, a solution obtained by dissolving 5.83 parts of sodium acetate in 7.00 parts of water was added to the resultant, and then the mixture was subjected to a reaction at 10° C. or less for 2 hours. After the completion of the reaction, 300 parts of water were added, and the mixture was stirred for 30 minutes. After that, the solid was separated by filtration and purified by a recrystallization method from N,N-dimethylformamide. Thus, 8.65 parts of Compound (29) were obtained (in 96.1% yield).

Next, 8.58 parts of Compound (29) and 0.4 part of palladium-activated carbon (palladium: 5%) were added to 150 parts of N,N-dimethylformamide, and the mixture was stirred under a hydrogen gas atmosphere (reaction pressure: 0.1 to 0.4 MPa) at 40° C. for 3 hours. After the completion of the reaction, the solution was separated by filtration and concentrated. Thus, 7.00 parts of Compound (30) were obtained (in 87.5% yield).

Next, 5.00 parts of Compound (30) and 1.48 parts of triethylamine were added to 25.0 parts of chloroform, the mixture was cooled with ice to 10° C. or less, and then 2.07 parts of Compound (31) were added. After that, the mixture was stirred at room temperature for 6 hours. After the completion of the reaction, the resultant was extracted with chloroform and concentrated. Thus, 5.35 parts of Compound (32) were obtained (in 97.3% yield).

Next, 2.50 parts of Compound (32), 140 parts of styrene (33), 1.77 parts of N,N,N′,N″,N″-pentamethyldiethylenetriamine, and 0.64 part of copper(I) bromide were added to 50.0 parts of N,N-dimethylformamide. After that, the mixture was stirred under a nitrogen atmosphere at 120° C. for 45 minutes. After the completion of the reaction, the resultant was extracted with chloroform and purified by reprecipitation with methanol. Thus, 86.2 parts of Compound (107) were obtained (in 60.5% yield).

The fact that the resultant product had the structure represented by the foregoing formula was confirmed with each apparatus described above. Results of analysis are shown below.

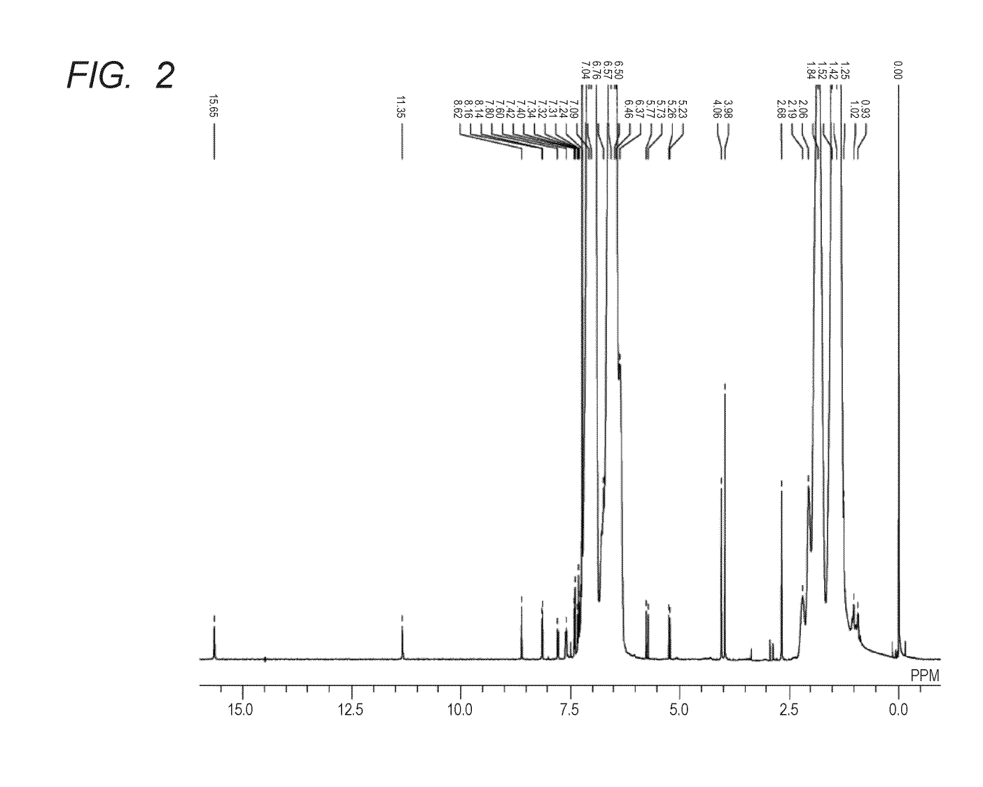

### (Results of Analysis of Compound (107) Having Azo Skeleton Structure)

[1] Results of molecular weight measurement (GPC):
[1] Weight average molecular weight (Mw)=36,377; number average molecular weight (Mn)=21,338
[2] Result of acid value measurement:
0 mgKOH/g
[3] Results of ¹N NMR (400 MHz, CDCl₃, room temperature) (see FIG. 2):

δ[ppm]=15.65 (s, 1H), 11.35 (s, 1H), 8.62 (s, 1H), 7.37-6.27 (m, 1294H), 4.06 (s, 3H), 3.98-4.06 (s, 3H), 2.47-1.05 (m, 786H)

### <Production Example of Compound (115)>

Compound (115) having an azo skeleton structure was produced according to the following scheme.

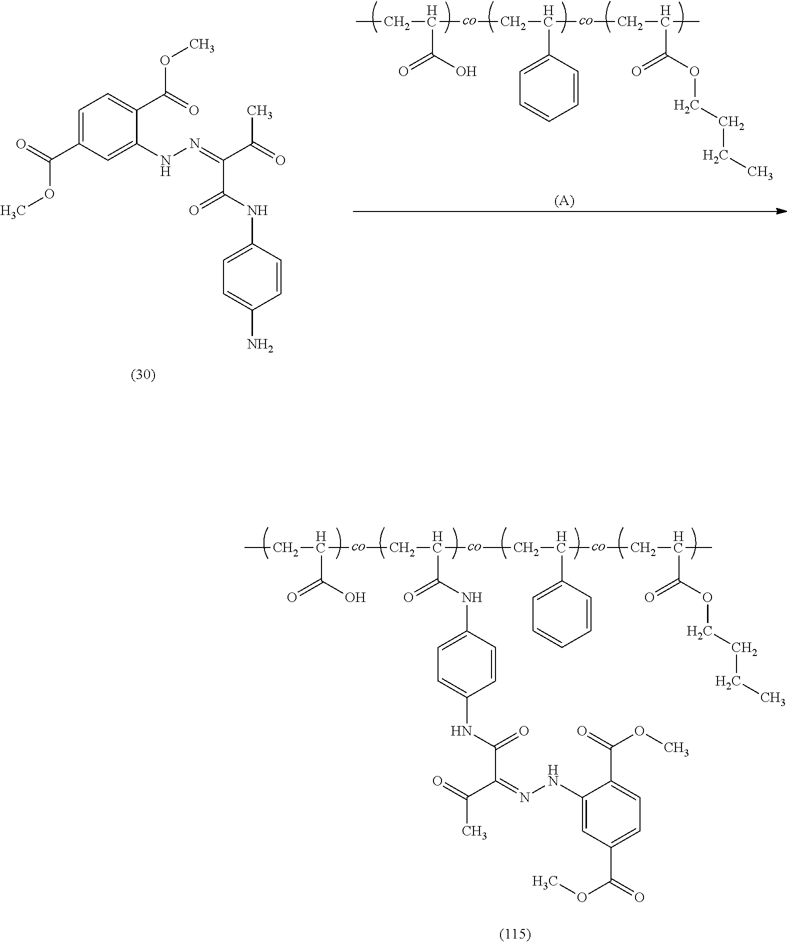

First, 100 parts of propylene glycol monomethyl ether were heated to reflux at a liquid temperature of 120° C. or more while the atmosphere was replaced with nitrogen, and thereto was added dropwise a mixture of 152 parts of styrene, 38 parts of butyl acrylate, 10 parts of acrylic acid, and 1.0 part of tert-butyl peroxybenzoate (organic peroxide-based polymerization initiator, manufactured by NOF CORPORATION, trade name: PERBUTYL Z) over 3 hours. After the completion of the dropwise addition, the solution was stirred for 3 hours, and then distilled under normal pressure while the liquid temperature was increased to 170° C. After the liquid temperature had reached 170° C., distillation was performed under a reduced pressure of 1 hPa for 1 hour to remove the solvent. Thus, resin solid matter was obtained. The solid matter was dissolved in tetrahydrofuran and subjected to reprecipitation with n-hexane to precipitate a solid, which was separated by filtration. Thus, a polymer site (A) was obtained.

Next, 1.98 parts of Compound (30) were added to 500 parts of tetrahydrofuran, and the mixture was heated to 80° C. to dissolve the compound. After the dissolution, the temperature was reduced to 50° C., and then 15 parts of the polymer site (A) were added and dissolved. 1.96 Parts of 1-ethyl-3-(3-dimethylaminopropyl)carbodiimide hydrochloride (EDC.HCl) were added, and then the resultant liquid was stirred at 50° C. for 5 hours. After that, the liquid temperature was gradually returned to room temperature, and the liquid was stirred overnight so that a reaction was completed. After the completion of the reaction, the solution was filtered, concentrated, and purified by reprecipitation with methanol. Thus, Compound (115) was obtained.

The fact that the resultant product had the structure represented by the foregoing formula was confirmed with each apparatus described above. Results of analysis are shown below.

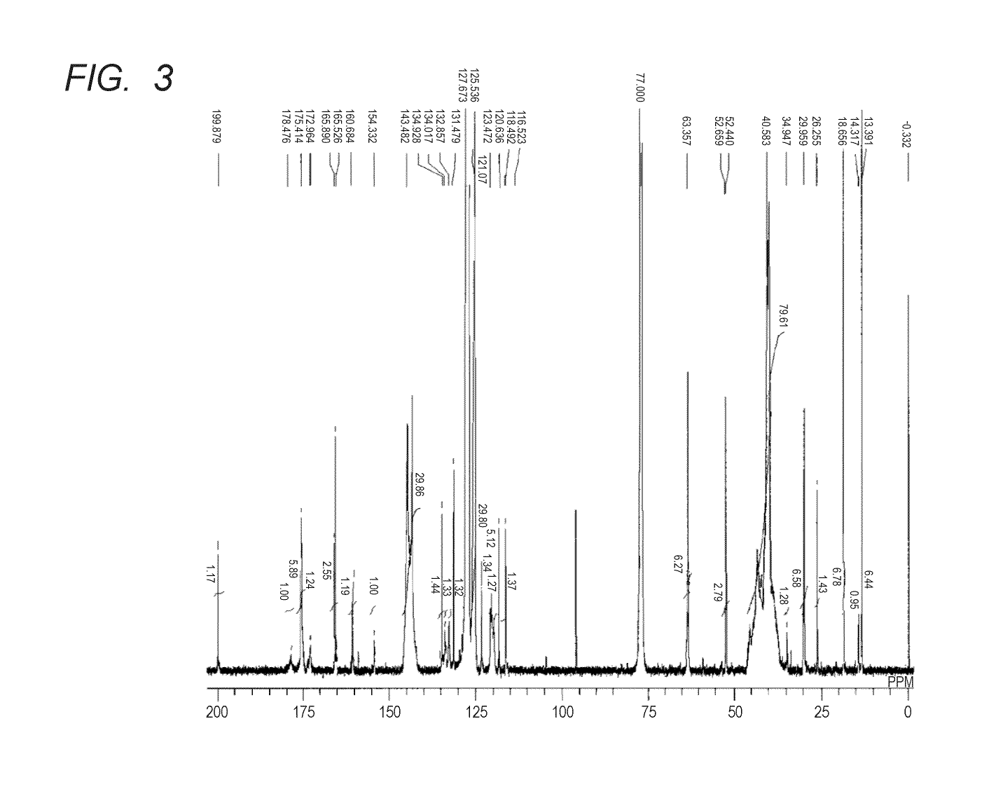

### (Results of Analysis of Compound (115) Having Azo Skeleton Structure)

[1] Results of molecular weight measurement (GPC): Weight average molecular weight (Mw)=37,125; number average molecular weight (Mn)=21,998
[2] Result of acid value measurement:
7.3 mgKOH/g
[3] Results of ¹³C NMR (600 MHz, CDCl₃, room temperature) (see FIG. 3):

δ[ppm]=199.88 (6C), 178.45, 175.41 (30C), 172.96 (6C), 165.89, 165.52, 160.68, 154.34, 143.48 (143C), 134.93, 134.02, 132.87, 131.48, 127.67, 125.54, 123.47, 120.85-120.63, 118.49, 116.52, 63.36, 52.66, 52.44, 40.58, 29.96, 26.26, 18.66, 13.39

### <Production Example of Compound (147)>

Compound (147) having an azo skeleton structure was produced according to the following scheme.

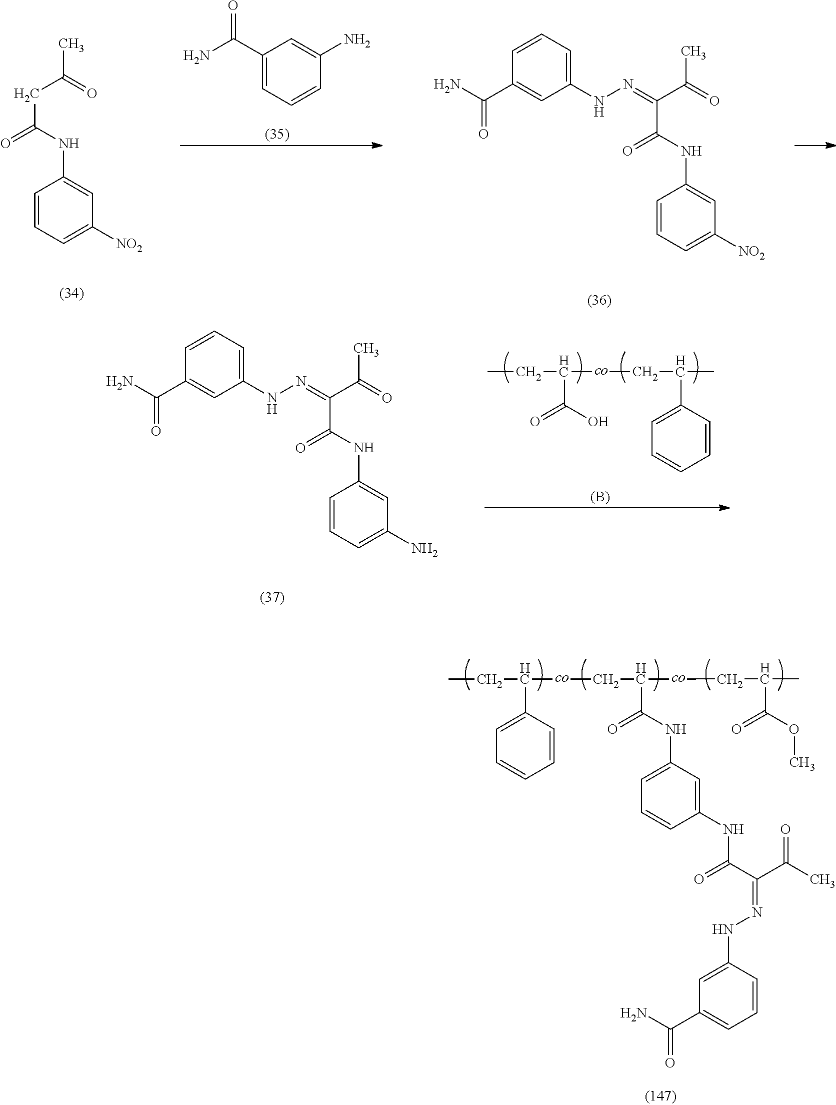

A polymer site (B) was obtained by the same synthesis method as that of the synthesis example of the polymer moiety (A) except that the raw materials were changed to 120 parts of styrene and 10 parts of acrylic acid.

100.0 Parts of DMF and 21.4 parts of concentrated hydrochloric acid were added to 10.0 parts of Compound (35), and the solution was cooled with ice to 5° C. or less. To the solution were added a solution obtained by dissolving 5.28 parts of sodium nitrite in 20.0 parts of water, and the mixture was subjected to a reaction at the above-mentioned temperature for 30 minutes. Next, 1.00 part of sulfamic acid was added, and the mixture was stirred for an additional 30 minutes (diazonium salt solution). 15.5 Parts of Compound (34) and 47.6 parts of potassium carbonate were added to 150.0 parts of DMF, and the mixture was cooled with ice to 5° C. or less. The diazonium salt solution was added to the cooled mixture, and the resultant was subjected to a reaction at the above-mentioned temperature for 2 hours. After the completion of the reaction, the reaction solution was discharged into 50 parts of water. After that, concentrated hydrochloric acid was added to adjust the pH to 1, and the resultant was stirred for 30 minutes to precipitate a solid, which was separated by filtration, washed with 150 parts of water, and then subjected to dispersion washing with 150 parts of methanol. Thus, 21.6 parts of Compound (36) were obtained (in 85.0% yield).

Next, 20.0 parts of Compound (36) were added to 300 parts of N,N-dimethylformamide, and the mixture was heated at 70° C. to dissolve the compound. The solution was cooled to room temperature, and then 2.28 parts of palladium-activated carbon (palladium: 5%) were added. The mixture was stirred under a hydrogen gas atmosphere (reaction pressure: 0.1 to 0.4 MPa) at room temperature for 6 hours. After the completion of the reaction, the solution was separated by filtration, the solvent was removed by distillation under reduced pressure, and then the residue was subjected to dispersion washing with methanol. Thus, 15.7 parts of Compound (37) were obtained (in 91.0% yield).

Next, 2.0 parts of Compound (37) were added to 500 parts of tetrahydrofuran, and the mixture was heated to 80° C. to dissolve the compound. After the dissolution, the temperature was reduced to 50° C., and then 15 parts of the polymer site (B) were added and dissolved. 2.0 Parts of 1-ethyl-3-(3-dimethylaminopropyl)carbodiimide hydrochloride (EDC.HCl) were added, and then the resultant liquid was stirred at 50° C. for 5 hours. After that, the liquid temperature was gradually returned to room temperature, and the liquid was stirred overnight so that a reaction was completed. After the completion of the reaction, the solution was filtered, concentrated, and purified by reprecipitation with methanol. Thus, 12.8 parts of Compound (147) having an azo skeleton structure were obtained.

The fact that the resultant product had the structure represented by the foregoing formula was confirmed with each apparatus described above. Results of analysis are shown below.

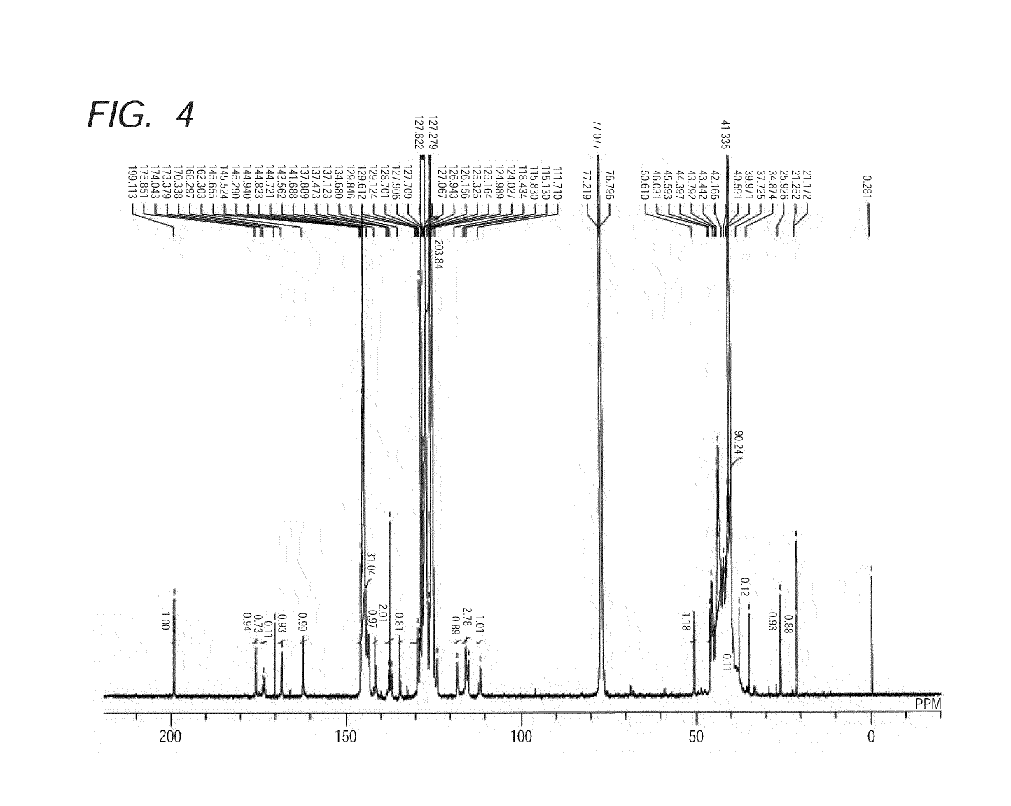

### (Results of Analysis of Compound (147) Having Azo Skeleton Structure)

[1] Result of molecular weight measurement (GPC): Number average molecular weight (Mn)=15,374
[2] Result of acid value measurement: 0.0 mgKOH/g
[3] Results of ¹³C NMR (600 MHz, CDCl₃, room temperature) (see FIG. 4):

δ[ppm]=199.6 (4C), 176.3 (5C), 174.2 (4C), 168.8, 162.7, 144.0-146.1 (130C), 142.0, 137.1-137.5, 134.6, 124.0-129.8, 118.0, 115.1-115.8, 111.7, 36.0-46.0, 25.9

### <Production Example of Compound (148)>

Compound (148) having an azo skeleton structure was produced according to the following scheme.

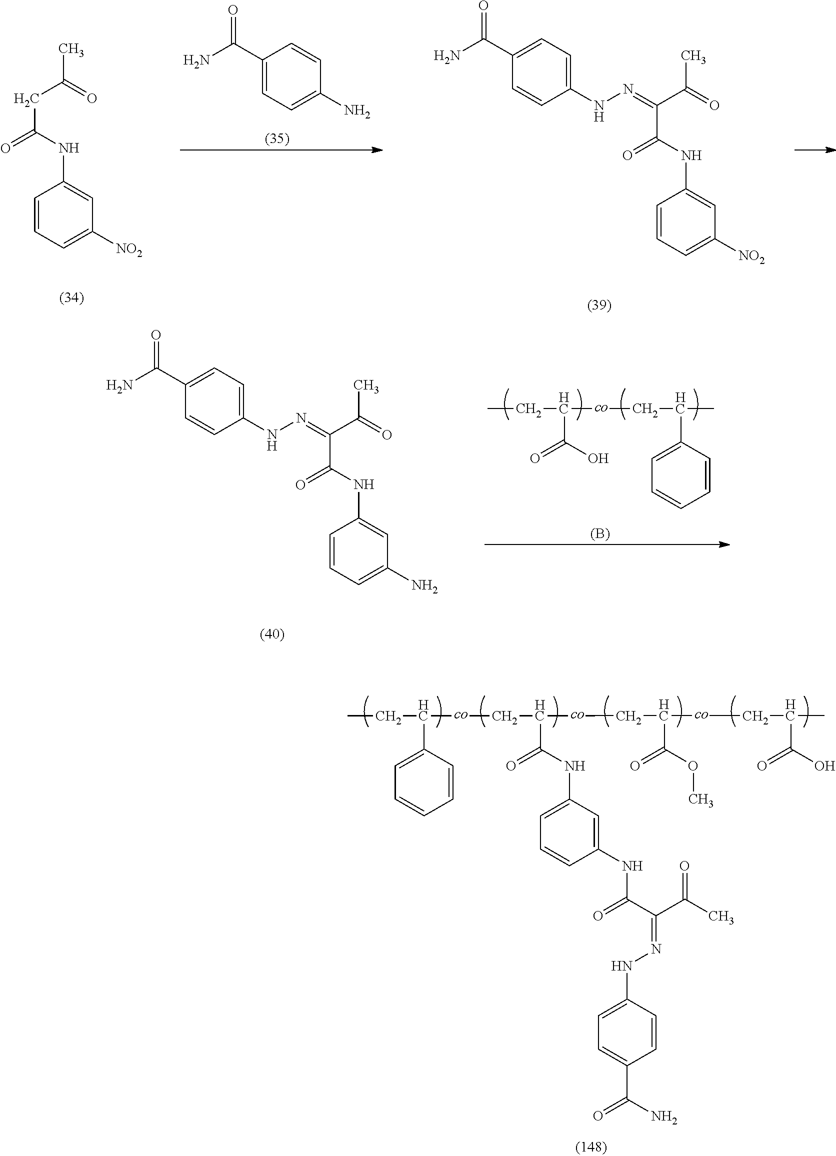

100.0 Parts of DMF and 21.4 parts of concentrated hydrochloric acid were added to 10.0 parts of Compound (38), and the solution was cooled with ice to 5° C. or less. To the solution were added a solution obtained by dissolving 5.28 parts of sodium nitrite in 20.0 parts of water, and the mixture was subjected to a reaction at the above-mentioned temperature for 30 minutes. Next, 1.00 part of sulfamic acid was added, and the mixture was stirred for an additional 30 minutes (diazonium salt solution). 15.5 Parts of Compound (34) and 47.6 parts of potassium carbonate were added to 150.0 parts of DMF, and the mixture was cooled with ice to 5° C. or less. The diazonium salt solution was added to the cooled mixture, and the resultant was subjected to a reaction at the above-mentioned temperature for 2 hours. After the completion of the reaction, the reaction solution was discharged into 50 parts of water. After that, concentrated hydrochloric acid was added to adjust the pH to 1, and the resultant was stirred for 30 minutes to precipitate a solid, which was separated by filtration, washed with 150 parts of water, and then subjected to dispersion washing with 150 parts of methanol. Thus, 22.4 parts of Compound (39) were obtained (in 88.3% yield).

Next, 20.0 parts of Compound (39) were added to 300 parts of N,N-dimethylformamide, and the mixture was heated at 70° C. to dissolve the compound. The solution was cooled to room temperature, and then 2.28 parts of palladium-activated carbon (palladium: 5%) were added. The mixture was stirred under a hydrogen gas atmosphere (reaction pressure: 0.1 to 0.4 MPa) at room temperature for 6 hours. After the completion of the reaction, the solution was separated by filtration, the solvent was removed by distillation under reduced pressure, and then the residue was subjected to dispersion washing with methanol. Thus, 16.3 parts of Compound (40) were obtained (in 94.6% yield).

Next, 25.0 parts of the polymer site (B) were added and dissolved in 250 parts of toluene. The reaction solution was cooled to 5° C. or less, and then 11.6 parts of oxalyl chloride were slowly added dropwise. The mixture was stirred for 15 hours while the liquid temperature was gradually returned to room temperature. The solvent was removed by distillation under reduced pressure, and then the residue was redissolved in 163 parts of N,N-dimethylacetamide. 3.00 Parts of Compound (40) were added to the solution, and the mixture was stirred at 65° C. for 3 hours. 27.8 Parts of methanol were added to the reaction solution, and the resultant liquid was stirred at 65° C. for an additional 3 hours. The liquid temperature was gradually returned to room temperature, and the liquid was stirred overnight so that a reaction was completed. After the completion of the reaction, the reaction solution was discharged into methanol/water to precipitate a precipitate, which was separated by filtration and purified by washing with methanol. Thus, 26.6 parts of Compound (148) having an azo skeleton structure were obtained.

The fact that the resultant product had the structure represented by the foregoing formula was confirmed with each apparatus described above. Results of analysis are shown below.

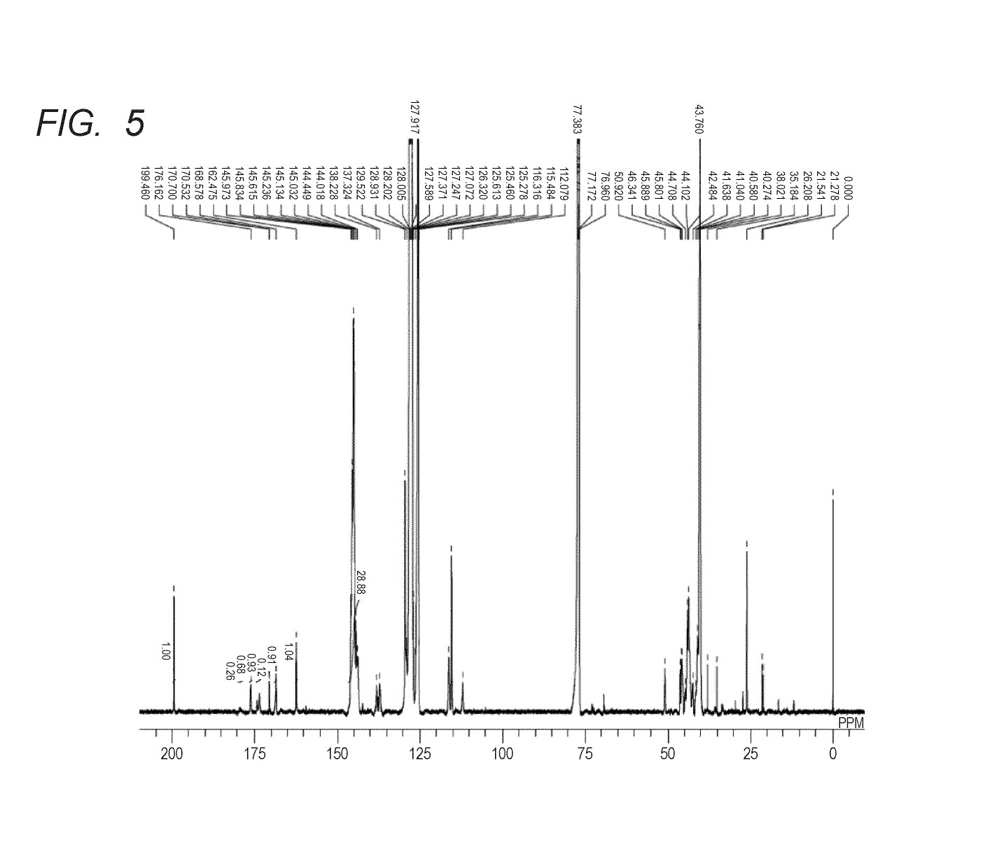

### (Results of Analysis of Compound (148) Having Azo Skeleton Structure)

[1] Result of GPC: number average molecular weight (Mn)=9,757
[2] Result of acid value measurement: 4.1 mgKOH/g
[3] Results of ¹³C NMR (600 MHz, CDCl₃, room temperature) (see FIG. 5):

δ[ppm]=199.5 (3C), 179.4 (1C), 176.2 (2C), 174.3-173.6 (3C), 170.1, 170.5, 168.6 (3C), 162.5 (3C), 146.0-144.0 (97C), 138.2, 137.3, 129.5, 128.2-127.1, 125.6-125.3, 116.3, 115.5, 112.1, 50.9, 46.3, 45.9, 44.1-43.8, 42.5, 41.0, 40.3, 38.0, 35.2, 26.2, 21.5, 21.3, 16.6, 11.9

### <Production Example of Compound (151)>

Compound (151) having an azo skeleton structure was produced according to the following scheme.

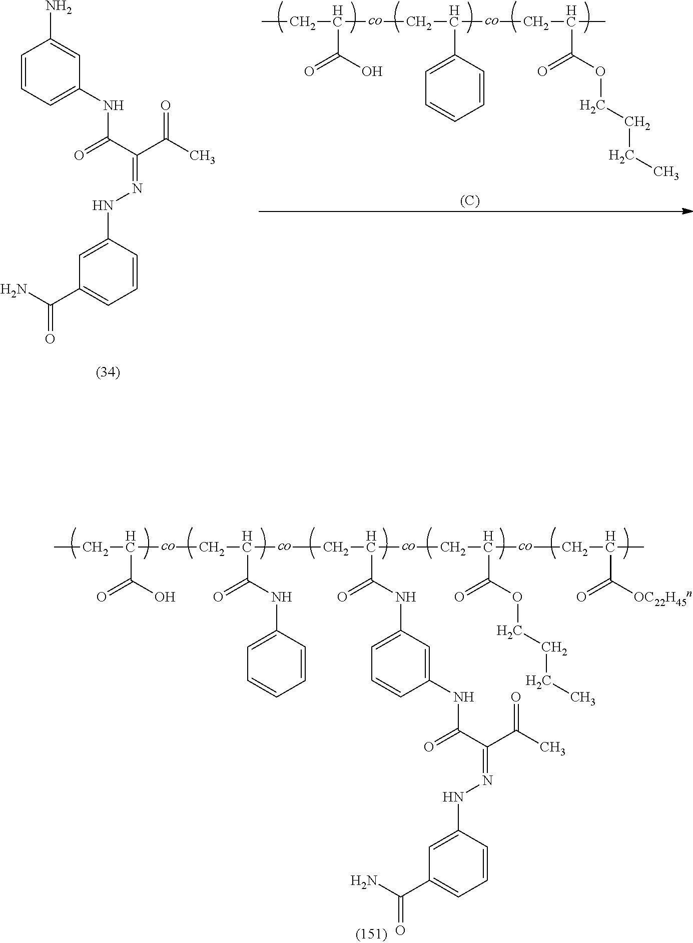

A polymer site (C) was obtained by the same synthesis method as that of the synthesis example of the polymer moiety (A) except that the raw materials were changed to 6.0 parts of styrene, 3.0 parts of butyl acrylate, and 1.0 part of acrylic acid.

Next, 2.0 parts of Compound (34) were added to 500 parts of tetrahydrofuran, and the mixture was heated to 80° C. to dissolve the compound. After the dissolution, the temperature was reduced to 50° C., and then 15 parts of the polymer site (C) were added and dissolved. 2.0 Parts of 1-ethyl-3-(3-dimethylaminopropyl)carbodiimide hydrochloride (EDC.HCl) were added, and then the resultant liquid was stirred at 50° C. for 5 hours. After that, 2.0 parts of docosanol were added, and then the resultant liquid was stirred at 65° C. for 1 hour. The liquid temperature was gradually returned to room temperature, and the liquid was stirred overnight so that a reaction was completed. After the completion of the reaction, the solution was filtered, concentrated, and purified by reprecipitation with methanol. Thus, 12.8 parts of Compound (151) having an azo skeleton structure were obtained.

The fact that the resultant product had the structure represented by the foregoing formula was confirmed with each apparatus described above. Results of analysis are shown below.

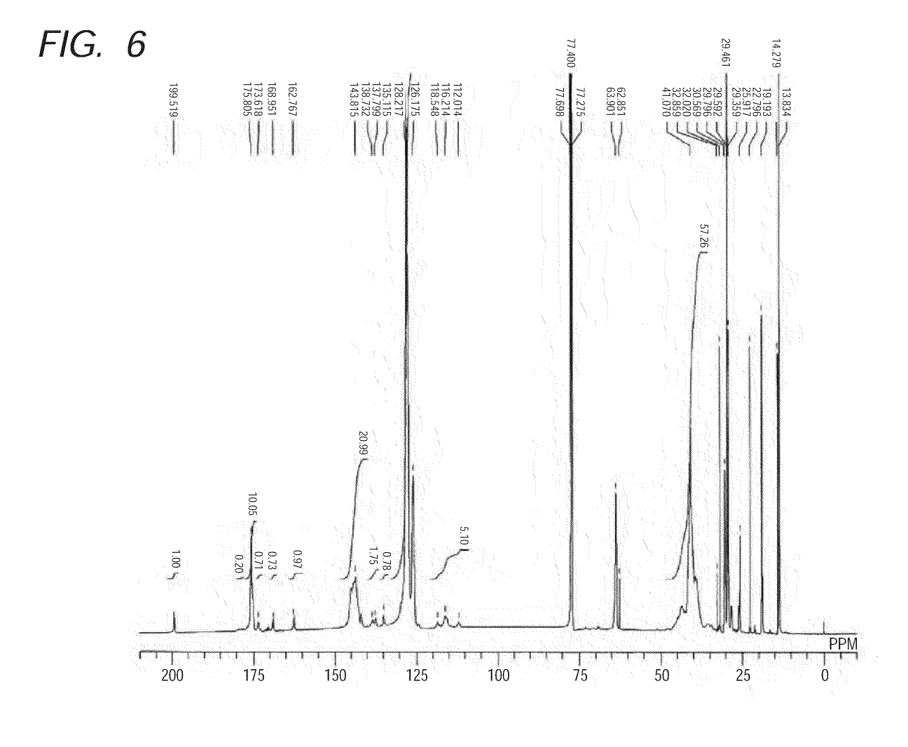

### (Results of Analysis of Compound (151) Having Azo Skeleton Structure)

[1] Result of GPC: number average molecular weight (Mn)=16,293
[2] Result of acid value measurement: 4.2 mgKOH/g
[3] Results of ¹³C NMR (600 MHz, CDCl₃, room temperature) (see FIG. 6):

δ[ppm]=199.52 (3C), 175.81 (36C), 173.62 (3C), 168.95, 162.77, 145.21, 143.82 (64C), 138.73, 137.80, 135.12, 128.22, 126.18, 118.55, 116.21, 112.02, 63.9, 46.50-37.00, 32.86, 32.02, 30.60, 29.80, 29.48, 25.92, 22.80, 19.19, 14.28, 13.83

### <Production Example of Compound (153)>

Compound (153) having an azo skeleton structure was produced according to the following scheme.

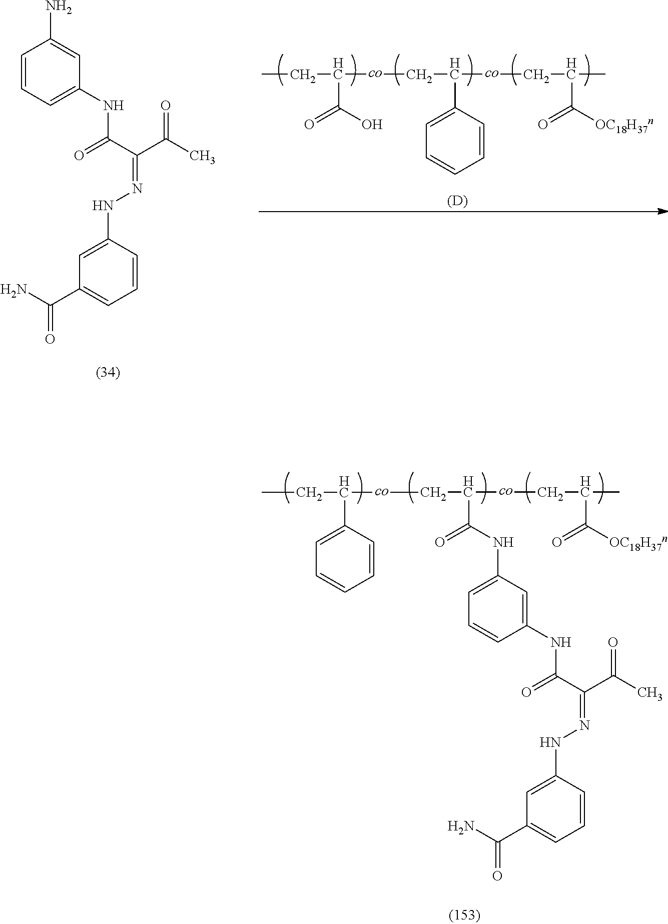

A polymer site (D) was obtained by the same synthesis method as that of the synthesis example of the polymer site (A) except that the raw materials were changed to 11.5 parts of styrene, 1.0 part of stearyl acrylate, and 0.5 part of acrylic acid.

Next, 2.0 parts of Compound (34) were added to 500 parts of tetrahydrofuran, and the mixture was heated to 80° C. to dissolve the compound. After the dissolution, the temperature was reduced to 50° C., and then 15 parts of the polymer site (D) were added and dissolved. 2.0 Parts of 1-ethyl-3-(3-dimethylaminopropyl)carbodiimide hydrochloride (EDC.HCl) were added, and then the resultant liquid was stirred at 50° C. for 5 hours. After that, the liquid temperature was gradually returned to room temperature, and the liquid was stirred overnight so that a reaction was completed. After the completion of the reaction, the solution was filtered, concentrated, and purified by reprecipitation with methanol. Thus, 12.5 parts of Compound (153) having an azo skeleton structure were obtained.

The fact that the resultant product had the structure represented by the foregoing formula was confirmed with each apparatus described above. Results of analysis are shown below.

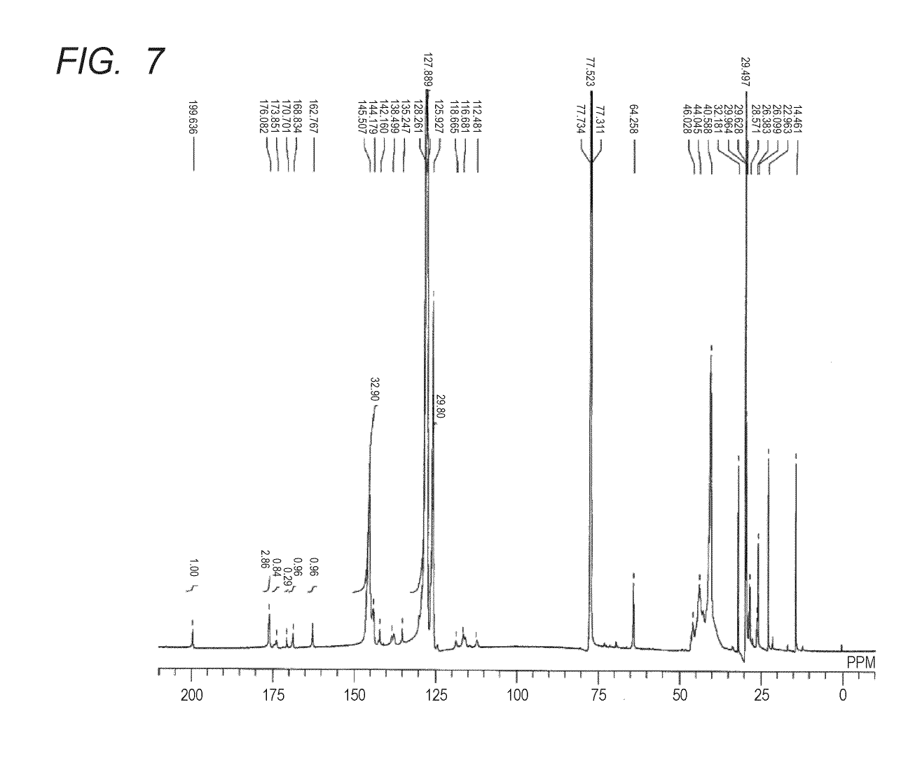

### (Results of Analysis of Compound (153) Having Azo Skeleton Structure)

[1] Result of GPC: Number average molecular weight (Mn)=22,047
[2] Result of acid value measurement: 0 mgKOH/g
[3] Results of ¹³C NMR (600 MHz, CDCl₃, room temperature) (see FIG. 7):

δ[ppm]=199.64 (3C), 176.08 (8C), 173.85 (3C), 170.70, 168.84, 162.77, 145.51 (93C), 144.18, 138.50, 135.25, 128.26, 127.89, 125.93, 118.67, 116.68, 112.48, 64.26, 50-36.00, 32.18, 29.57, 26.38, 22.66, 14.46

Compounds (102) to (106), (108) to (114), (116) to (146), (149), (150), (152), (154), and (155) each having the azo skeleton structure represented by the formula (1) were produced by the same operations as those of the production examples of Compounds (101), (107), (115), (147), (148), (151), and (153) each having an azo skeleton structure described above.

Tables 1-1 and 1-2 below show the compounds each having an azo skeleton structure of the present invention.

TABLE 1-1
Compounds each having azo
skeleton unit of the present invention

| | Sequential arrangement | | | | | | | |
|---|---|---|---|---|---|---|---|---|
| | of monomers | | | | | | | |
| Compound | Copolymerization ratio | | | | | | | |
| No. | (X/Y/Z/W) | R₁ | R₂ | R₈ | R₉ | R₁₀ | R₁₁ | R₁₂ |
| 101 | poly(X₁-c-W) | —CH₃ | —NHPh | —H | —H | —R₁₀-1 | —H | —H |
| | (X₁/W = 100/4) | | | | | | | |
| 102 | poly(X₁-c-W) | —CH₃ | —NHPh | —H | —H | —R₁₀-2 | —H | —H |
| | (X₁/W = 100/4) | | | | | | | |
| 103 | poly(X1-c-W) | —N(CH₃)₂ | —N(CH₃)₂ | —H | —H | —R₁₀-1 | —H | —H |
| | (X1/W = 100/4) | | | | | | | |
| 104 | poly(X₁-c-W) | —OH | —OH | —H | —H | —R₁₀-1 | —H | —H |
| | (X₁/W = 100/4) | | | | | | | |
| 105 | poly(X1-c-W) | —CH₃ | —CH₃ | —H | —H | —R₁₀-1 | —H | —H |
| | (X₁/W = 100/4) | | | | | | | |
| 106 | α-W-polyX₁ | —CH₃ | —NH—Ph | —H | —H | —R₁₀-3 | —H | —H |
| | (X₁/W = 110/1) | | | | | | | |
| 107 | α-W-polyX₁ | —CH₃ | —R₂-1 | —COOCH₃ | —H | —H | —COOCH₃ | —H |
| | (X₁/W = 260/1) | | | | | | | |
| 108 | α-W-poly(X₁-c-Y₁) | —CH₃ | —R₂-1 | —COOCH₃ | —H | —H | —COOCH₃ | —H |
| | (X₁/Y₁/W = 71/18/1) | | | | | | | |
| 109 | α-W-poly(X₁-c-Y₁) | —CH₃ | —R₂-1 | —COOCH₃ | —H | —H | —COOCH₃ | —H |
| | (X₁/Y₁/W = 43/54/1) | | | | | | | |
| 110 | α-W-poly(X₁-c-Y₁) | —CH₃ | —R₂-1 | —COOCH₃ | —H | —H | —COOCH₃ | —H |
| | (X₁/Y₁/W = 18/88/1) | | | | | | | |
| 111 | α-W-poly(X₁-b-Y₁) | —CH₃ | —R₂-1 | —COOCH₃ | —H | —H | —COOCH₃ | —H |
| | (X₁/Y₁/W = 46/50/1) | | | | | | | |
| 112 | α-W-polyY₁ | —CH₃ | —R₂-1 | —COOCH₃ | —H | —H | —COOCH₃ | —H |
| | (Y₁/W = 101/1) | | | | | | | |
| 113 | PolyX₁-W-PolyX₁ | —R₁-1 | —R₂-1 | —COOCH₃ | —H | —H | —COOCH₃ | —H |
| | (X₁/ W = 392/1) | | | | | | | |
| 114 | PolyX₁-W-PolyX₁ | —R₁-2 | —R₂-2 | —COOCH₃ | —H | —H | —COOCH₃ | —H |
| | (X₁/W = 386/1) | | | | | | | |
| 115 | poly(X₁-c-Y₁-c-Z₁-c-W) | —CH₃ | —R₂-3 | —COOCH₃ | —H | —H | —COOCH₃ | —H |
| | (X₁/Y₁/Z₁/W = 143/30/5/6) | | | | | | | |
| 116 | poly(X₁-c-Y₁-c-Z₁-c-W) | —CH₃ | —R₂-3 | —COOCH₃ | —H | —H | —H | —H |
| | (X₁/Y₁/Z₁/W = 143/30/5/6) | | | | | | | |
| 117 | poly(X₁-c-Y₁-c-Z₁-c-W) | —CH₃ | —R₂-3 | —H | —COOCH₃ | —H | —H | —H |
| | (X₁/Y₁/Z₁/W = 143/30/5/6) | | | | | | | |
| 118 | poly(X₁-c-Y₁-c-Z₁-c-W) | —CH₃ | —R₂-3 | —H | —H | —COOCH₃ | —H | —H |
| | (X₁/Y₁/Z₁/W = 143/30/5/6) | | | | | | | |
| 119 | poly(X₁-c-Y₁-c-Z₁-c-W) | —CH₃ | —R₂-3 | —H | —H | —H | —H | —H |
| | (X₁/Y₁/Z₁/W = 143/30/5/6) | | | | | | | |
| 120 | poly(X₁-c-Y₁-c-Z₁-c-W) | —Ph | —R₂-3 | —COOCH₃ | —H | —H | —COOCH₃ | —H |
| | (X₁/Y₁/Z₁/W = 143/30/5/6) | | | | | | | |
| 121 | poly(X₁-c-Y₁-c-Z₁-c-W) | —CH₃ | —R₂-3 | —H | —COOCH₃ | —H | —COOCH₃ | —H |
| | (X₁/Y₁/Z₁/W = 143/30/5/6) | | | | | | | |
| 122 | poly(X₁-c-Y₁-c-Z₁-c-W) | —CH₃ | —R₂-3 | —CONHCH₃ | —H | —H | —CONHCH₃ | —H |
| | (X₁/Y₁/Z₁/W = 143/30/5/6) | | | | | | | |
| 123 | poly(X₁-c-Y₁-c-Z₁-c-W) | —CH₃ | —R₂-3 | —COOH | —H | —H | —COOH | —H |
| | (X₁/Y₁/Z₁/W = 143/30/5/6) | | | | | | | |
| 124 | poly(X₁-c-Y₁-c-Z₁-c-W) | —CH₃ | —R₂-3 | —COOPr(i) | —H | —H | —COOPr(i) | —H |
| | (X₁/Y₁/Z₁/W = 143/30/5/6) | | | | | | | |
| 125 | poly(X₂-c-Y₂-c-Z₁-c-W) | —CH₃ | —R₂-3 | —COOCH₃ | —H | —H | —COOCH₃ | —H |
| | (X₂/Y₂/Z₁/W = 143/30/5/6) | | | | | | | |
| 126 | poly(X₁-c-Y₆-c-Z₁-c-W) | —CH₃ | —R₂-3 | —COOCH₃ | —H | —H | —COOCH₃ | —H |
| | (X₁/Y₆/Z₁/W = 143/30/5/6) | | | | | | | |
| 127 | poly(X₁-c-Y₇-c-Z₁-c-W) | —CH₃ | —R₂-3 | —COOCH₃ | —H | —H | —COOCH₃ | —H |
| | (X₁/Y₇/Z₁/W = 143/30/5/6) | | | | | | | |
| 128 | poly(X₁-c-Y₁-c-W) | —CH₃ | —R₂-3 | —COOCH₃ | —H | —H | —COOCH₃ | —H |
| | (X₁/Y₁/W = 143/30/11) | | | | | | | |
| 129 | poly(X₁-c-Z₁-c-W) | —CH₃ | —R₂-3 | —COOCH₃ | —H | —H | —COOCH₃ | —H |
| | (X₁/Z₁/W = 221/3/8) | | | | | | | |
| 130 | poly(X₁-c-W) | —CH₃ | —R₂-3 | —COOCH₃ | —H | —H | —COOCH₃ | —H |
| | (X₁/W = 221/11) | | | | | | | |

TABLE 1-2
Compounds each having azo skeleton unit of the present invention

| Compound | Sequential arrangement | | | | | | | |
|---|---|---|---|---|---|---|---|---|
| No. | of monomers | R₁ | R₂ | R₈ | R₉ | R₁₀ | R₁₁ | R₁₂ |
| 131 | polyX₁-b-polyW | —CH₃ | —R₂-3 | —COOCH₃ | —H | —H | —COOCH₃ | —H |
| | (X₁/W = 84/5) | | | | | | | |
| 132 | poly(Y₁-c-Z₁-c-W) | —CH₃ | —R₂-3 | —COOCH₃ | —H | —H | —COOCH₃ | —H |
| | (Y₁/Z₁/W = 90/2/8) | | | | | | | |
| 133 | poly(X₁-c-Y₁-c-Z₁-c-W) | —CH₃ | —R₂-3 | —COOCH₃ | —H | —H | —COOCH₃ | —H |
| | (X₁/Y₁/Z₁/W = 10/11/5/2) | | | | | | | |
| 134 | poly(X₁-c-Z₁-c-W) | —CH₃ | —R₂-3 | —COOCH₃ | —H | —H | —COOCH₃ | —H |
| | (X₁/Z₁/W = 974/384/197) | | | | | | | |
| 135 | poly(X₂-c-Y₆-c-W) | —CH₃ | —R₂-3 | —COOCH₃ | —H | —H | —COOCH₃ | —H |
| | (X₂/Y₆/W = 142/30/11) | | | | | | | |
| 136 | α-W-polyX₁ | —R₁-1 | —NHPh | —COOCH₃ | —H | —H | —COOCH₃ | —H |
| | (X₁/W = 110/1) | | | | | | | |
| 137 | poly(X₁-c-Y₁-c-Z₁-c-W) | —R₁-3 | —NHCH₃ | —COOCH₃ | —H | —H | —COOCH₃ | —H |
| | (X₁/Y₁/Z₁/W = 141/29/9/2) | | | | | | | |
| 138 | poly(X₁-c-Y₁-c-Z₁-c-W) | —R₁-3 | —N(CH₃)₂ | —COOCH₃ | —H | —H | —COOCH₃ | —H |
| | (X₁/Y₁/Z₁/W = 141/29/9/2) | | | | | | | |
| 139 | poly(X₁-c-Y₁-c-Z₁-c-W) | —R₁-3 | —OEt | —COOCH₃ | —H | —H | —COOCH₃ | —H |
| | (X₁/Y₁/Z₁/W = 141/29/9/2) | | | | | | | |
| 140 | poly(X₁-c-Y₁-c-Z₁-c-W) (X₁/Y₁/Z₁/W = 141/29/9/2) | —R₁-3 | 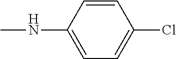 | —COOCH₃ | —H | —H | —COOCH₃ | —H |
| 141 | poly(X₁-c-Y₁-c-Z₁-c-W) (X₁/Y₁/Z₁/W = 141/29/9/2) | —R₁-3 | 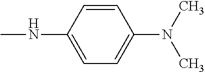 | —COOCH₃ | —H | —H | —COOCH₃ | —H |
| 142 | poly(X₁-c-Y₁-c-Z₁-c-W) (X₁/Y₁/Z₁/W = 141/29/9/2) | —R₁-3 | 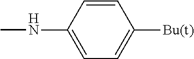 | —COOCH₃ | —H | —H | —COOCH₃ | —H |
| 143 | poly(X₁-c-Y₁-c-Z₁-c-W) (X₁/Y₁/Z₁/W = 141/29/9/2) | —R₁-3 | 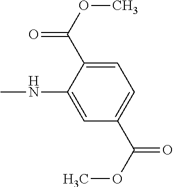 | —COOCH₃ | —H | —H | —COOCH₃ | —H |
| 144 | poly(X₁-c-Y₁-c-Z₁-c-W) | —R₁-3 | —NHCH₃ | —COOCH₃ | —H | —H | —COOCH₃ | —H |
| | (X₁/Y₁/Z₁/W = 141/29/9/2) | | | | | | | |
| 145 | poly(X₁-c-Y₁-c-Z₁-c-W) | —R₁-3 | —NHPh | —COOCH₃ | —H | —H | —COOCH₃ | —H |
| | (X₁/Y₁/Z₁/W = 141/29/9/2) | | | | | | | |
| 146 | poly(X₁-c-Y₂-c-Z₁-c-W) | —CH₃ | —R₂-4 | —CONH₂ | —H | —H | —H | —H |
| | (X₁/Y₂/Z₁/W = 97/3/1/3) | | | | | | | |
| 147 | poly(X₁-c-Y₂-c-W) | —CH₃ | —R₂-4 | —H | —CONH₂ | —H | —H | —H |
| | (X₁/Y₂/W = 130/5/4) | | | | | | | |
| 148 | poly(X₁-c-Y₂-c-Z₁-c-W) | —CH₃ | —R₂-4 | —H | —H | —CONH₂ | —H | —H |
| | (X₁/Y₂/Z₁/W = 97/3/1/3) | | | | | | | |
| 149 | poly(X₁-c-Y₂-c-Z₁-c-W) | —CH₃ | —R₂-4 | —CONH₂ | —H | —CONH₂ | —H | —H |
| | (X₁/Y₂/Z₁/W = 97/3/1/3) | | | | | | | |
| 150 | poly(X₁-c-Y₁-c-Y₂-c-Z₁-c-W) | —CH₃ | —R₂-4 | —H | —CONH₂ | —H | —H | —H |
| | (X₁/Y₁/Y₂/Z₁/W = 88/8/4/1/3) | | | | | | | |
| 151 | poly(X₁-c-Y₁-c-Y₄-c-Z₁-c-W) | —CH₃ | —R₂-4 | —H | —CONH₂ | —H | —H | —H |
| | (X₁/Y₁/Y₂/Z₁/W = 64/30/6/1/3) | | | | | | | |
| 152 | poly(X₁-c-Y₁-c-Y₄-c-Z₁-c-W) | —CH₃ | —R₂-4 | —H | —CONH₂ | —H | —H | —H |
| | (X₁/Y₁/Y₄/Z₁/W = 88/8/4/1/3) | | | | | | | |
| 154 | poly(X₁-c-Y₄-c-Z₁-c-W) | —CH₃ | —R₂-4 | —H | —CONH₂ | —H | —H | —H |
| | (X₁/Y₄/Z₁/W = 97/3/1/3) | | | | | | | |
| 155 | poly(X₁-c-Y₅-c-Z₁-c-W) | —CH₃ | —R₂-4 | —H | —CONH₂ | —H | —H | —H |
| | (X₁/Y₅/Z₁/W = 97/3/1/3) | | | | | | | |

(In Tables 1-1 and 1-2: the prefix “a” represents a terminal group attached to the left side of a structure; X₁, X₂, Y₁ to Y₇, Z₁, W, R₁-1 to R₁-3, R₂-1 to R₂-4, and R₁₀-1 to R₁₀-3 represent the following structures; and “Pr (i)” represents an unsubstituted isopropyl group, “Bu(t)” represents an unsubstituted tertiary butyl group, “Ph” represents an unsubstituted phenyl group, and “Et” represents an ethyl group.)

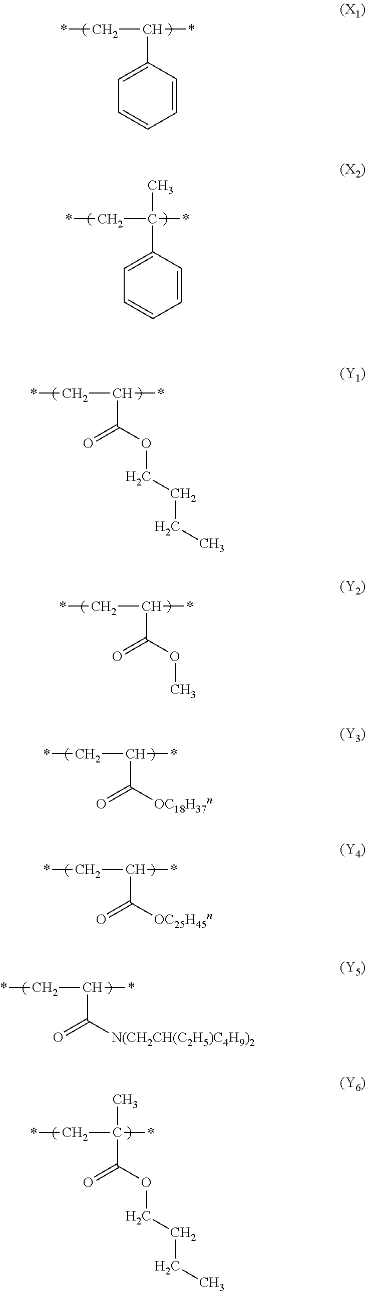

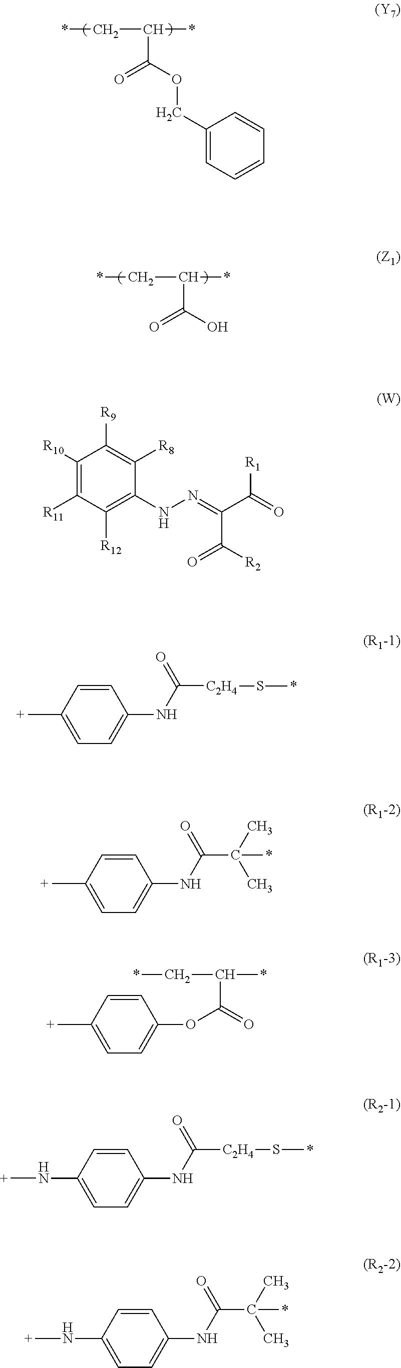

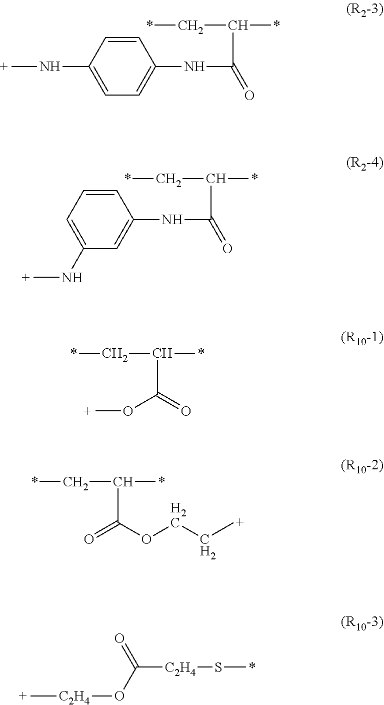

(“*” in X₁, X₂, Y₁ to Y₇, Z₁, R₁-1 to R₁-3, R₂-1 to R₂-4, and R₁₀-1 to R₁₀-3 represents a site to be bound to a polymer main chain. “+” in R₁-1 to R₁-3, R₂-1 to R₂-4, and R₁₀-1 to R₁₀-3 represents a site to be bound to the formula (W).)

### Example 2

First, pigment dispersion liquids each containing carbon black and a compound having an azo skeleton structure, for use in a toner production process according to the suspension polymerization method, were prepared by the following methods.

### <Pigment Dispersion Liquid Preparation Example 1>

30.0 Parts of carbon black (a) (specific surface area=65 m²/g, average particle diameter=30 nm, pH=9.0) as a coloring agent, 3.0 parts of Compound (101) having an azo skeleton structure described above, 180 parts of styrene as a water-insoluble solvent, and 130 parts of glass beads (1 mmφ) were mixed, and were then dispersed with an attritor (manufactured by NIPPON COKE & ENGINEERING CO., LTD.) for 3 hours, followed by filtration with a mesh. Thus, a pigment dispersion liquid (DISI) was obtained.

### <Pigment Dispersion Liquid Preparation Example 2>

Pigment dispersion liquids (DIS2) to (DIS55) were obtained by the same operations as those of Pigment Dispersion Liquid Preparation Example 1 above except that Compound (101) having an azo skeleton structure was changed to Compounds (102) to (155) each having an azo skeleton structure, respectively.

### <Pigment Dispersion Liquid Preparation Example 3>

Pigment dispersion liquids (DIS56) and (DIS57) were obtained by the same operations as those of Pigment Dispersion Liquid Preparation Example 1 above except that the carbon black (a) was changed to carbon black (b) (specific surface area=77 m²/g, average particle diameter=28 nm, pH=7.5) and carbon black (c) (specific surface area=370 m²/g, average particle diameter=13 nm, pH=3.0), respectively.

### Comparative Example 1

Pigment dispersion liquids to serve as reference values for evaluation and comparative pigment dispersion liquids were prepared by the following methods.

### <Reference Pigment Dispersion Liquid Preparation Example 1>

A reference pigment dispersion liquid (DIS58) was obtained by the same respective operations as those of Pigment Dispersion Liquid Preparation Example 1 in Example 2 above except that Compound (101) having an azo skeleton structure was not added.

### <Reference Pigment Dispersion Liquid Preparation Example 2>

Reference pigment dispersion liquids (DIS59) and (DIS60) were obtained by the same respective operations as those of Pigment Dispersion Liquid Preparation Example 3 in Example 2 above except that Compound (101) having an azo skeleton structure was not added.

### <Comparative Pigment Dispersion Liquid Preparation Example 1>

Comparative pigment dispersion liquids (DIS61) to (DIS63) were obtained by the same operations as those of Pigment Dispersion Liquid Preparation Example 1 in Example 2 above except that Compound (101) having an azo skeleton structure was changed to the styrene homopolymer (Mw=10,976) (Comparative Compound 1), styrene/butyl acrylate (copolymerization ratio (mass ratio)=80/20) random copolymer (Mw=10,804) (Comparative Compound 2), and styrene/butyl acrylate (copolymerization ratio (mass ratio)=95/5) block copolymer (Mw=9,718) (Comparative Compound 3) described in Patent Literature 1, respectively.

### Example 3

The pigment dispersion liquids were evaluated by the following method.

The compound having an azo dye skeleton structure of the present invention was evaluated for its pigment dispersibility by performing a gloss test for an applied film of the pigment dispersion. That is, the pigment dispersion liquid was skimmed with a dropping pipette, mounted in a linear fashion on the top of super art paper (SA Kinfuji, 180 kg, 80×160, manufactured by Oji Paper Co., Ltd.), and uniformly applied onto the art paper with a wire bar (#10). A gloss (angle of reflection: 75°) after drying was measured with a gloss meter “Gloss Meter VG2000” (manufactured by NIPPON DENSHOKU INDUSTRIES CO., LTD.) and evaluated by the following criteria. It should be noted that as carbon black is dispersed more finely, the smoothness of the applied film is improved and its gloss is also improved.

A: The gloss value is 80% or more.
B: The gloss value is 50% or more and less than 80%.
C: The gloss value is 20% or more and less than 50%.
D: The gloss value is less than 20%.

The pigment dispersibility was judged as satisfactory when the gloss improvement ratio was 50% or more.

Table 2 shows the results of the evaluation for the pigment dispersibility of the present invention.

TABLE 2
Results of evaluation
for pigment dispersibility

| | | | Evaluation |
|---|---|---|---|
| | | | for |
| Pigment | | | dispersebility |
| dispersion | | | (degree of |
| liquid | Compound | Pigment | gloss) |
| DIS1 | (101) | (a) | A(102) |
| DIS2 | (102) | (a) | A(112) |
| DIS3 | (103) | (a) | A(101) |
| DIS4 | (104) | (a) | A(98) |
| DIS5 | (105) | (a) | A(110) |
| DIS6 | (106) | (a) | A(100) |
| DIS7 | (107) | (a) | A(103) |
| DIS8 | (108) | (a) | A(108) |
| DIS9 | (109) | (a) | A(99) |
| DIS10 | (110) | (a) | A(104) |
| DIS11 | (111) | (a) | A(98) |
| DIS12 | (112) | (a) | A(99) |
| DIS13 | (113) | (a) | A(99) |
| DIS14 | (114) | (a) | A(120) |
| DIS15 | (115) | (a) | A(111) |
| DIS16 | (116) | (a) | A(107) |
| DIS17 | (117) | (a) | A(97) |
| DIS18 | (118) | (a) | A(117) |
| DIS19 | (119) | (a) | A(110) |
| DIS20 | (120) | (a) | A(100) |
| DIS21 | (121) | (a) | A(105) |
| DIS22 | (122) | (a) | A(103) |
| DIS23 | (123) | (a) | A(108) |
| DIS24 | (124) | (a) | A(109) |
| DIS25 | (125) | (a) | A(99) |
| DIS26 | (126) | (a) | A(96) |
| DIS27 | (127) | (a) | A(104) |
| DIS28 | (128) | (a) | A(110) |
| DIS29 | (129) | (a) | A(114) |
| DIS30 | (130) | (a) | A(99) |
| DIS31 | (131) | (a) | A(96) |
| DIS32 | (132) | (a) | A(106) |
| DIS33 | (133) | (a) | A(109) |
| DIS34 | (134) | (a) | A(110) |
| DIS35 | (135) | (a) | A(110) |
| DIS36 | (136) | (a) | A(118) |
| DIS37 | (137) | (a) | A(109) |
| DIS38 | (138) | (a) | A(102) |
| DIS39 | (139) | (a) | A(97) |
| DIS40 | (140) | (a) | A(107) |
| DIS41 | (141) | (a) | A(112) |
| DIS42 | (142) | (a) | A(90) |
| DIS43 | (143) | (a) | A(96) |
| DIS44 | (144) | (a) | A(103) |
| DIS45 | (145) | (a) | A(109) |
| DIS46 | (146) | (a) | A(81) |
| DIS47 | (147) | (a) | A(110) |
| DIS48 | (148) | (a) | A(110) |
| DIS49 | (149) | (a) | A(99) |
| DIS50 | (150) | (a) | A(102) |
| DIS51 | (151) | (a) | A(106) |
| DIS52 | (152) | (a) | A(115) |
| DIS53 | (153) | (a) | A(116) |
| DIS54 | (154) | (a) | A(100) |
| DIS55 | (155) | (a) | A(109) |
| DIS56 | (101) | (b) | B(60) |
| DIS57 | (101) | (c) | A(110) |
| DIS58 | None | (a) | D(5) |
| DIS59 | None | (b) | C(42) |
| DIS60 | None | (c) | D(2) |
| DIS61 | Comparative | (a) | D(17) |
| | Compound (1) | | |
| DIS62 | Comparative | (a) | C(23) |
| | Compound (2) | | |
| DIS63 | Comparative | (a) | D(15) |
| | Compound (3) | | |

### Example 4

Next, the toner of the present invention according to the suspension polymerization method was produced by the following method.

### <Toner Production Example 1>

710 Parts of ion-exchanged water and 450 parts of a 0.1-mol/l aqueous solution of Na₃PO₄ were added to a 2-1 four-necked flask provided with a high-speed stirring apparatus T.K. homomixer (manufactured by PRIMIX Corporation), and the mixture was heated to 60° C. while the number of revolutions was adjusted to 12,000 rpm. 68 Parts of a 1.0-mol/l aqueous solution of CaCl₂ were gradually added to the heated mixture to prepare an aqueous medium containing a fine, poorly water-soluble dispersion stabilizer Ca₃(PO₄)₂. Next, the following composition was heated to 60° C., and was then uniformly dissolved and dispersed with a high-speed stirring apparatus T.K. homomixer (manufactured by PRIMIX Corporation) at 5,000 rpm.

| | | |
|---|---|---|
| Pigment dispersion liquid | 132 | parts |
| (DIS1) described above | | |
| Styrene monomer | 46 | parts |
| n-Butyl acrylate monomer | 34 | parts |
| Polar resin (saturated polyester | 10 | parts |
| resin (terephthalic | | |
| acid-propylene oxide | | |
| modified bisphenol A, acid value: | | |
| 15, peak molecular weight: 6,000)) | | |
| Ester wax (maximum | 25 | parts |
| endothermic peak in DSC | | |
| measurement = 70° C., Mn = 704) | | |
| Aluminum salicylate compound | 2 | parts |
| (manufactured by Orient | | |
| Chemical Industries Co., Ltd., | | |
| trade name: BONTRON E- | | |
| 108) | | |
| Divinylbenzene monomer | 0.1 | part |

10 Parts of 2,2′-azobis(2,4-dimethylvaleronitrile) as a polymerization initiator were added to the composition, and the mixture was loaded into the aqueous medium. The resultant was granulated for 15 minutes while the number of revolutions was maintained at 12,000 rpm. After that, the stirrer was changed from the high-speed stirrer to a propeller stirring blade, and polymerization was continued at a liquid temperature of 60° C. for 5 hours. After that, the liquid temperature was increased to 80° C., and then the polymerization was continued for 8 hours. After the completion of the polymerization reaction, the remaining monomer was removed by distillation at 80° C. under reduced pressure. After that, the residue was cooled to 30° C. Thus, a polymer fine particle dispersion liquid was obtained.

The polymer fine particle dispersion liquid thus obtained was transferred to a washing container, and then dilute hydrochloric acid was added to the dispersion liquid under stirring. The mixture was stirred at a pH of 1.5 for 2 hours so that compounds of phosphoric acid and calcium including Ca₃(PO₄)₂ were dissolved. After that, the resultant was subjected to solid-liquid separation with a filter. Thus, polymer fine particles were obtained. The polymer fine particles were loaded into water, and the mixture was stirred so as to turn into a dispersion liquid again. After that, the dispersion liquid was subjected to solid-liquid separation with a filter. The redispersion of the polymer fine particles in water and the solid-liquid separation were repeatedly performed until the compounds of phosphoric acid and calcium including Ca₃(PO₄)₂ were sufficiently removed. After that, the polymer fine particles after the final solid-liquid separation were sufficiently dried with a dryer. Thus, toner particles were obtained.

100 Parts of the resultant toner particles were dry-mixed with 1.0 part of hydrophobic silica fine powder whose surface had been treated with hexamethyldisilazane (number average primary particle diameter: 7 nm), 0.15 part of rutile type titanium oxide fine powder (number average primary particle diameter: 45 nm), and 0.5 part of rutile type titanium oxide fine powder (number average primary particle diameter: 200 nm) with a Henschel mixer (manufactured by NIPPON COKE & ENGINEERING CO., LTD.) for 5 minutes. Thus, a toner (TNR1) was obtained.

### <Toner Production Example 2>

Toners (TNR2) to (TNR55) of the present invention were obtained in the same manner as in Toner Production Example 1 above except that the pigment dispersion liquid (DIS1) in Toner Production Example 1 was changed to the pigment dispersion liquids (DIS2) to (DIS55), respectively.

### <Toner Production Example 3>

Toners (TNR56) and (TNR57) of the present invention were obtained in the same manner as in Toner Production Example 1 above except that the pigment dispersion liquid (DIS1) in Toner Production Example 1 was changed to the pigment dispersion liquids (DIS56) and (DIS57), respectively.

### Example 5

Next, the toner of the present invention according to the suspension granulation method was produced by the following method.

### <Toner Production Example 4>

180 Parts of ethyl acetate, 30 parts of the carbon black (a), 3.0 parts of Compound (101) having an azo skeleton structure described above, and 130 parts of glass beads (1 mmφ) were mixed, and were then dispersed with an attritor (manufactured by NIPPON COKE & ENGINEERING CO., LTD.) for 3 hours, followed by filtration with a mesh. Thus, a pigment dispersion liquid was prepared.

The following composition was dispersed with a ball mill for 24 hours. Thus, 200 parts of a toner composition mixed liquid were obtained.

| | | |
|---|---|---|
| Pigment dispersion liquid described above | 96.0 | parts |
| Polar resin (saturated polyester | 85.0 | parts |
| resin (polycondensate | | |
| of propylene oxide modified | | |
| bisphenol A and phthalic | | |
| acid, Tg = 75.9° C., Mw = 11,000, | | |
| Mn = 4,200, acid value: 11)) | | |
| Hydrocarbon wax (Fischer Tropsch wax, | 9.0 | parts |
| maximum | | |
| endothermic peak in DSC | | |
| measurement = 80° C., | | |
| Mw = 750) | | |
| Aluminum salicylate | 2 | parts |
| compound (BONTRON E-108, | | |
| manufactured by | | |
| Orient Chemical Industries Co., Ltd.) | | |
| Ethyl acetate (solvent) | 10.0 | parts |

The following composition was dispersed with a ball mill for 24 hours to dissolve carboxymethylcellulose. Thus, an aqueous medium was obtained.

| | | |
|---|---|---|
| Calcium carbonate | 20.0 | parts |
| (coated with acrylic acid-based | | |
| copolymer) | | |
| Carboxymethylcellulose | 0.5 | part |
| (Cellogen BS-H, manufactured by | | |
| DAI-ICHI KOGYO | | |
| SEIYAKU CO., LTD.) | | |
| Ion-exchanged water | 99.5 | parts |

1,200 Parts of the aqueous medium were charged in a high-speed stirring apparatus T.K. homomixer (manufactured by PRIMIX Corporation), and were then stirred at a circumferential speed of a rotating blade of 20 m/sec. During the stirring, 1,000 parts of the toner composition mixed liquid were charged into the aqueous medium. The mixture was stirred for 1 minute while being kept constant at 25° C. Thus, a suspension liquid was obtained.

While 2,200 parts of the suspension liquid were stirred with a Fullzone blade (manufactured by Kobelco Eco-Solutions Co., Ltd.) at a circumferential speed of 45 m/min, the liquid temperature was kept constant at 40° C., and a vapor phase on the surface of the suspension liquid was forcedly aspirated with a blower to initiate solvent removal. At that time, 75 parts of ammonia water diluted to 1% as an ionic substance were added after a lapse of 15 minutes from the initiation of the solvent removal. Subsequently, 25 parts of the ammonia water were added after a lapse of 1 hour from the initiation of the solvent removal. Subsequently, 25 parts of the ammonia water were added after a lapse of 2 hours from the initiation of the solvent removal. Finally, 25 parts of the ammonia water were added after a lapse of 3 hours from the initiation of the solvent removal so that the total addition amount was 150 parts. In addition, the resultant liquid was held for 17 hours from the initiation of the solvent removal while the liquid temperature was kept at 40° C. Thus, a toner dispersion liquid in which the solvent (ethyl acetate) had been removed from the suspended particles was obtained.

80 Parts of 10-mol/l hydrochloric acid were added to 300 parts of the toner dispersion liquid obtained in the solvent-removing step. In addition, the mixture was subjected to neutralization treatment with a 0.1-mol/l aqueous solution of sodium hydroxide. After that, washing with ion-exchanged water by suction filtration was repeated four times. Thus, a toner cake was obtained. The resultant toner cake was dried with a vacuum dryer and sifted with a sieve having an opening of 45 μm. Thus, toner particles were obtained. Any operation hereafter was the same as that in Toner Production Example 1 above. Thus, a toner (TNR58) was obtained.

### <Toner Production Example 5>

Toners (TNR59) to (TNR112) of the present invention were obtained by the same operations except that Compound (101) having an azo skeleton structure in Toner Production Example 4 above was changed to Compounds (102) to (155), respectively.

### <Toner Production Example 6>

Toners (TNR113) and (TNR114) of the present invention were obtained in the same manner as in Toner Production Example 4 above except that the carbon black (a) was changed to the carbon black (b) and the carbon black (c), respectively.

### Comparative Example 2

For the toners of the present invention produced in Example 4 above, toners to serve as reference values for evaluation and comparative toners were produced by the following methods.

### <Reference Toner Production Example 1>

A reference toner (TNR115) was obtained in the same manner as in Toner Production Example 1 above except that the pigment dispersion liquid (DIS1) in Toner Production Example 1 was changed to the pigment dispersion liquid (DIS58).

### <Reference Toner Production Example 2>

Reference toners (TNR116) and (TNR117) were obtained in the same manner as in Toner Production Example 3 above except that the pigment dispersion liquid (DIS1) in Toner Production Example 3 was changed to the pigment dispersion liquids (DIS59) and (DIS60), respectively.

### <Comparative Toner Production Example 1>

Comparative toners (TNR118) to (TNR120) were obtained in the same manner as in Toner Production Example 1 above except that the pigment dispersion liquid (DIS1) in Toner Production Example 1 was changed to the pigment dispersion liquids (DIS61) to (DIS63), respectively.

### Comparative Example 3

For the toners of the present invention produced in Example 5, toners to serve as reference values for evaluation and comparative toners were produced by the following methods.

### <Reference Toner Production Example 3>

A reference toner (TNR121) was obtained in the same manner as in Toner Production Example 4 except that Compound (101) having an azo skeleton structure described above was not added.

### <Reference Toner Production Example 4>

Reference toners (TNR122) and (TNR123) were obtained in the same manner as in Toner Production Example 6 except that Compound (101) having an azo skeleton structure described above was not added.

### <Comparative Toner Production Example 2>

Comparative toners (TNR124) to (TNR126) were obtained in the same manner as in Toner Production Example 4 except that Compound (101) having an azo skeleton structure described above was changed to the styrene homopolymer (Mw=10,976) (Comparative Compound 1), styrene/butyl acrylate (copolymerization ratio (mass ratio)=80/20) random copolymer (Mw=10,804) (Comparative Compound 2), and styrene/butyl acrylate (copolymerization ratio (mass ratio)=95/5) block copolymer (Mw=9,718) (Comparative Compound 3) described in Patent Literature 1, respectively.

### Example 6

The toners obtained in the present invention were evaluated by the following methods.

Image samples were output with the toners (TNR1) to (TNR126) and subjected to comparative evaluations for image characteristics to be described later. It should be noted that, in the comparison of the image characteristics, a paper-feeding durability test was performed using a remodeled machine of an LBP-5300 (manufactured by Canon Inc.) as an image-forming apparatus (hereinafter, abbreviated as LBP). Details of the remodeling were as follows: a developing blade in a process cartridge (hereinafter, abbreviated as CRG) was exchanged to an SUS blade having a thickness of 8 (μm); and the apparatus was configured so as to be able to apply a blade bias of −200 (V) with respect to a developing bias to be applied to a developing roller as a toner carrying member.

### <Measurement of Weight Average Particle Diameter D4 and Number Average Particle Diameter D1 of Toner>

A Coulter Multisizer (manufactured by Beckman Coulter, Inc.) was used, and an interface for outputting a number distribution and a volume distribution (manufactured by Nikkaki Bios Co., Ltd.) and a personal computer were connected thereto. Sodium chloride, specifically, a 1% aqueous solution of NaCl is used for an electrolytic solution. For example, an ISOTON R-II (manufactured by Beckman Coulter, Inc.) may be used. A specific measurement procedure, which is described in each of the catalog of the Coulter Multisizer (February 2002 edition) published by Beckman Coulter, Inc. and the operation manual of the measurement apparatus, is as follows.

To 100 to 150 ml of the electrolytic aqueous solution were added 2 to 20 mg of a measurement sample. The electrolytic solution in which the sample had been suspended was subjected to dispersion treatment with an ultrasonic disperser for about 1 to 3 minutes, and then the volume and number of toner particles of 2.0 μm or more and 64.0 μm or less were measured with a 100-μm aperture of the Coulter Multisizer. The resultant data was sorted into 16 channels, and then a weight average particle diameter D4, a number average particle diameter D1, and D4/D1 were determined.

Table 3 shows the results of the measurements of the weight average particle diameter D4 and D4/D1 of each of the toners of the present invention according to the suspension polymerization method, and Table 4 shows the results of the measurements of the weight average particle diameter D4 and D4/D1 of each of the toners of the present invention according to the suspension granulation method.

### <Evaluation of Toner for Coloring Power>

Under a normal temperature, normal humidity (N/N (23.5° C., 60% RH)) environment, a solid image having a toner laid-on level of 0.5 mg/cm² was produced on transfer paper (75-g/m² paper). The solid image was measured for its density with a reflection densitometer Spectrolino (manufactured by GretagMacbeth). The coloring power of each toner was evaluated based on the improvement ratio of the solid image density.

For the improvement ratio of the solid image density of each of the toners (TNR1) to (TNR55), the solid image density of the reference toner (TNR115) was used as a reference value. Further, for the improvement ratio of the solid image density of the toner (TNR56), the solid image density of the reference toner (TNR116) was used as a reference value. Further, for the improvement ratio of the solid image density of the toner (TNR57), the solid image density of the reference toner (TNR117) was used as a reference value.

For the improvement ratio of the solid image density of each of the toners (TNR58) to (TNR112), the solid image density of the reference toner (TNR121) was used as a reference value. Further, for the improvement ratio of the solid image density of the toner (TNR113), the solid image density of the reference toner (TNR122) was used as a reference value. Further, for the improvement ratio of the solid image density of the toner (TNR114), the solid image density of the reference toner (TNR123) was used as a reference value.

Evaluation criteria for the coloring power of a toner are shown below.
A: The improvement ratio of the solid image density is 60% or more.
B: The improvement ratio of the solid image density is 40% or more and less than 60%.
C: The improvement ratio of the solid image density is 20% or more and less than 40%.
D: The improvement ratio of the solid image density is less than 20%.

The coloring power was judged as satisfactory when the improvement ratio of the solid image density was 20% or more.

Table 3 shows the results of the evaluation for the coloring power of each of the toners of the present invention according to the suspension polymerization method, and Table 4 shows the results of the evaluation for the coloring power of each of the toners of the present invention according to the suspension granulation method.

### <Evaluation of Toner for Fogging>

Under a normal temperature, normal humidity (N/N (23.5° C., 60% RH)) environment, and under a high-temperature, high-humidity (H/H (30° C., 80% RH)) environment, in an image output test involving printing out an image having a printing ratio of 2% on up to 10,000 sheets of transfer paper (75-g/m² paper), an image having a white background portion was output at the time of the completion of the durability evaluation, and a fogging density (%) (=Dr (%)−Ds (%)) was calculated as a difference between the whiteness degree of the white background portion of the printout image (reflectance Ds(%)) and the whiteness degree of the transfer paper (average reflectance Dr (%)) measured with a “REFLECTMETER MODEL TC-6DS” (manufactured by Tokyo Denshoku CO., LTD.). Then, fogging at the time of the completion of the durability evaluation was evaluated.

Evaluation criteria for the fogging of a toner are shown below.
A: The fogging density is less than 1.0%.
B: The fogging density is 1.0% or more to less than 2.0%.
C: The fogging density is 2.0% or more to less than 3.0%.
D: The fogging density is 3.0% or more.

The fogging was judged as being sufficiently suppressed when the fogging density was less than 3.0%.

Table 3 shows the results of the evaluation for the fogging of each of the toners of the present invention according to the suspension polymerization method, and Table 4 shows the results of the evaluation for the fogging of each of the toners of the present invention according to the suspension granulation method.

### <Evaluation of Toner for Transfer Efficiency>

Under a high-temperature, high-humidity (H/H (30° C., 80% RH)) environment, in an image output test involving printing out an image having a printing ratio of 2% on up to 10,000 sheets of transfer paper (75-g/m² paper), transfer efficiency was checked at the time of the completion of the durability evaluation. A solid image having a toner laid-on level of 0.65 mg/cm² was developed on a drum, and then transferred to transfer paper (75-g/m² paper) to provide an unfixed image. The transfer efficiency was determined based on weight changes in the amount of toner on the drum and the amount of toner on the transfer paper (Transfer efficiency in the case where the entire amount of the toner on the drum was transferred onto the transfer paper is defined as 100%.).

Evaluation criteria for the transfer efficiency of a toner are shown below.
A: The transfer efficiency is 95% or more.
B: The transfer efficiency is 90% or more and less than 95%.
C: The transfer efficiency is 80% or more and less than 90%.
D: The transfer efficiency is less than 80%.

The transfer efficiency was judged as satisfactory when the transfer efficiency was 80% or more.

Table 3 shows the results of the evaluation for the transfer efficiency of each of the toners of the present invention according to the suspension polymerization method, and Table 4 shows the results of the evaluation for the transfer efficiency of each of the toners of the present invention according to the suspension granulation method.

### Comparative Example 4

The comparative toners (TNR118) to (TNR120) were each evaluated for its weight average particle diameter D4 and D4/D1, coloring power, fogging, and transfer efficiency by the same methods as those of Example 6.

For the improvement ratio of the solid image density of each of the comparative toners (TNR118) to (TNR120), the solid image density of the reference toner (TNR115) was used as a reference value.

For the improvement ratio of the solid image density of each of the comparative toners (TNR124) to (TNR126), the solid image density of the reference toner (TNR121) was used as a reference value.

Table 3 shows the results of the evaluations of the comparative toners according to the suspension polymerization method, and Table 4 shows the results of the evaluations of the comparative toners according to the suspension granulation method.

TABLE 3
Results of evaluations of toners of the present
invention according to suspension polymerization

| | | | | Toner weight | | Coloring | | | |
|---|---|---|---|---|---|---|---|---|---|
| | Pigment | | | average | | power | | | |
| | dispersion | | | diameter D4 | | of | Fogging | Fogging | Transfer |
| Toner | liquid | Compound | Pigment | [μm] | D4/D1 | toner | (N/N) | (H/H) | efficiency |
| TNR1 | DIS1 | (101) | (a) | 6.11 | 1.19 | A | A | A | A |
| TNR2 | DIS2 | (102) | (a) | 6.20 | 1.10 | A | A | A | A |
| TNR3 | DIS3 | (103) | (a) | 6.22 | 1.20 | A | A | A | A |
| TNR4 | DIS4 | (104) | (a) | 6.06 | 1.28 | A | A | A | A |
| TNR5 | DIS5 | (105) | (a) | 6.01 | 1.20 | A | A | A | A |
| TNR6 | DIS6 | (106) | (a) | 6.21 | 1.19 | A | A | A | A |
| TNR7 | DIS7 | (107) | (a) | 6.14 | 1.17 | A | A | A | A |
| TNR8 | DIS8 | (108) | (a) | 6.11 | 1.30 | A | A | A | A |
| TNR9 | DIS9 | (109) | (a) | 6.21 | 1.22 | A | A | A | A |
| TNR10 | DIS10 | (110) | (a) | 6.23 | 1.20 | A | A | A | A |
| TNR11 | DIS11 | (111) | (a) | 6.08 | 1.13 | A | A | A | A |
| TNR12 | DIS12 | (112) | (a) | 6.22 | 1.16 | A | A | A | A |
| TNR13 | DIS13 | (113) | (a) | 6.29 | 1.18 | A | A | A | A |
| TNR14 | DIS14 | (114) | (a) | 6.19 | 1.25 | A | A | A | A |
| TNR15 | DIS15 | (115) | (a) | 6.18 | 1.28 | A | A | A | A |
| TNR16 | DIS16 | (116) | (a) | 6.12 | 1.11 | A | A | A | A |
| TNR17 | DIS17 | (117) | (a) | 6.13 | 1.19 | A | A | A | A |
| TNR18 | DIS18 | (118) | (a) | 6.06 | 1.29 | A | A | A | A |
| TNR19 | DIS19 | (119) | (a) | 6.22 | 1.30 | A | A | A | A |
| TNR20 | DIS20 | (120) | (a) | 6.25 | 1.28 | A | A | A | A |
| TNR21 | DIS21 | (121) | (a) | 6.02 | 1.11 | A | A | A | A |
| TNR22 | DIS22 | (122) | (a) | 6.21 | 1.16 | A | A | A | A |
| TNR23 | DIS23 | (123) | (a) | 6.28 | 1.19 | A | A | A | A |
| TNR24 | DIS24 | (124) | (a) | 6.07 | 1.19 | A | A | A | A |
| TNR25 | DIS25 | (125) | (a) | 6.21 | 1.20 | A | A | A | A |
| TNR26 | DIS26 | (126) | (a) | 6.17 | 1.16 | A | A | A | A |
| TNR27 | DIS27 | (127) | (a) | 6.15 | 1.15 | A | A | A | A |
| TNR28 | DIS28 | (128) | (a) | 6.11 | 1.22 | A | A | A | A |
| TNR29 | DIS29 | (129) | (a) | 6.11 | 1.16 | A | A | A | A |
| TNR30 | DIS30 | (130) | (a) | 6.17 | 1.21 | A | A | A | A |
| TNR31 | DIS31 | (131) | (a) | 6.19 | 1.21 | A | A | A | A |
| TNR32 | DIS32 | (132) | (a) | 6.11 | 1.20 | A | A | A | A |
| TNR33 | DIS33 | (133) | (a) | 6.07 | 1.15 | A | A | A | A |
| TNR34 | DIS34 | (134) | (a) | 6.05 | 1.20 | A | A | A | A |
| TNR35 | DIS35 | (135) | (a) | 6.25 | 1.29 | A | A | A | A |
| TNR36 | DIS36 | (136) | (a) | 6.19 | 1.30 | A | A | A | A |
| TNR37 | DIS37 | (137) | (a) | 6.12 | 1.25 | A | A | A | A |
| TNR38 | DIS38 | (138) | (a) | 6.10 | 1.21 | A | A | A | A |
| TNR39 | DIS39 | (139) | (a) | 6.27 | 1.17 | A | A | A | A |
| TNR40 | DIS40 | (140) | (a) | 6.30 | 1.30 | A | A | A | A |
| TNR41 | DIS41 | (141) | (a) | 6.07 | 1.19 | A | A | A | A |
| TNR42 | DIS42 | (142) | (a) | 6.12 | 1.29 | A | A | A | A |
| TNR43 | DIS43 | (143) | (a) | 6.05 | 1.30 | A | A | A | A |
| TNR44 | DIS44 | (144) | (a) | 6.14 | 1.19 | A | A | A | A |
| TNR45 | DIS45 | (145) | (a) | 6.15 | 1.25 | A | A | A | A |
| TNR46 | DIS46 | (146) | (a) | 6.10 | 1.16 | A | A | A | A |
| TNR47 | DIS47 | (147) | (a) | 6.05 | 1.11 | A | A | A | A |
| TNR48 | DIS48 | (148) | (a) | 6.10 | 1.25 | A | A | A | A |
| TNR49 | DIS49 | (149) | (a) | 6.13 | 1.30 | A | A | A | A |
| TNR50 | DIS50 | (150) | (a) | 6.22 | 1.27 | A | A | A | A |
| TNR51 | DIS51 | (151) | (a) | 6.08 | 1.18 | A | A | A | A |
| TNR52 | DIS52 | (152) | (a) | 6.10 | 1.19 | A | A | A | A |
| TNR53 | DIS53 | (153) | (a) | 6.20 | 1.20 | A | A | A | A |
| TNR54 | DIS54 | (154) | (a) | 6.16 | 1.16 | A | A | A | A |
| TNR55 | DIS55 | (155) | (a) | 6.04 | 1.23 | A | A | A | A |
| TNR56 | DIS56 | (101) | (b) | 6.48 | 1.30 | B | B | B | B |
| TNR57 | DIS57 | (101) | (c) | 6.11 | 1.13 | B | B | B | B |
| TNR115 | DIS58 | None | (a) | 6.42 | 1.43 | — | D | D | D |
| TNR116 | DIS59 | None | (b) | 6.28 | 1.32 | — | D | D | D |
| TNR117 | DIS60 | None | (c) | 6.26 | 1.21 | — | D | D | D |
| TNR118 | DIS61 | Comparative | (a) | 6.69 | 1.19 | D | D | D | D |
| | | Compound | | | | | | | |
| | | (1) | | | | | | | |
| TNR119 | DIS62 | Comparative | (a) | 6.52 | 1.21 | D | D | D | D |
| | | Compound | | | | | | | |
| | | (2) | | | | | | | |
| TNR120 | DIS63 | Comparative | (a) | 6.61 | 1.18 | D | D | D | D |
| | | Compound | | | | | | | |
| | | (3) | | | | | | | |

TABLE 4
Results of evaluations of toners of the present
invention according to suspension granulation

| | | | Toner | | | | | |
|---|---|---|---|---|---|---|---|---|
| | | | weight | | Coloring | | | |
| | | | average | | power | | | |
| | | | diameter | | of | Fogging | Fogging | Transfer |
| Toner | Compound | Pigment | D4 [μm] | D4/D1 | toner | (N/N) | (H/H) | efficiency |
| TNR58 | (101) | (a) | 6.01 | 1.10 | A | A | A | A |
| TNR59 | (102) | (a) | 6.30 | 1.20 | A | A | A | A |
| TNR60 | (103) | (a) | 6.20 | 1.22 | A | A | A | A |
| TNR61 | (104) | (a) | 6.05 | 1.29 | A | A | A | A |
| TNR62 | (105) | (a) | 6.11 | 1.18 | A | A | A | A |
| TNR63 | (106) | (a) | 6.25 | 1.16 | A | A | A | A |
| TNR64 | (107) | (a) | 6.28 | 1.27 | A | A | A | A |
| TNR65 | (108) | (a) | 6.00 | 1.31 | A | A | A | A |
| TNR66 | (109) | (a) | 6.26 | 1.24 | A | A | A | A |
| TNR67 | (110) | (a) | 6.43 | 1.18 | A | A | A | A |
| TNR68 | (111) | (a) | 6.30 | 1.10 | A | A | A | A |
| TNR69 | (112) | (a) | 6.29 | 1.18 | A | A | A | A |
| TNR70 | (113) | (a) | 6.28 | 1.18 | A | A | A | A |
| TNR71 | (114) | (a) | 6.12 | 1.26 | A | A | A | A |
| TNR72 | (115) | (a) | 6.08 | 1.19 | A | A | A | A |
| TNR73 | (116) | (a) | 6.17 | 1.16 | A | A | A | A |
| TNR74 | (117) | (a) | 6.08 | 1.30 | A | A | A | A |
| TNR75 | (118) | (a) | 6.20 | 1.29 | A | A | A | A |
| TNR76 | (119) | (a) | 6.21 | 1.31 | A | A | A | A |
| TNR77 | (120) | (a) | 6.16 | 1.16 | A | A | A | A |
| TNR78 | (121) | (a) | 6.12 | 1.13 | A | A | A | A |
| TNR79 | (122) | (a) | 6.23 | 1.19 | A | A | A | A |
| TNR80 | (123) | (a) | 6.19 | 1.25 | A | A | A | A |
| TNR81 | (124) | (a) | 6.03 | 1.17 | A | A | A | A |
| TNR82 | (125) | (a) | 6.04 | 1.24 | A | A | A | A |
| TNR83 | (126) | (a) | 6.19 | 1.26 | A | A | A | A |
| TNR84 | (127) | (a) | 6.35 | 1.25 | A | A | A | A |
| TNR85 | (128) | (a) | 6.38 | 1.20 | A | A | A | A |
| TNR86 | (129) | (a) | 6.13 | 1.17 | A | A | A | A |
| TNR87 | (130) | (a) | 6.19 | 1.28 | A | A | A | A |
| TNR88 | (131) | (a) | 6.20 | 1.25 | A | A | A | A |
| TNR89 | (132) | (a) | 6.14 | 1.34 | A | A | A | A |
| TNR90 | (133) | (a) | 6.05 | 1.25 | A | A | A | A |
| TNR91 | (134) | (a) | 6.04 | 1.24 | A | A | A | A |
| TNR92 | (135) | (a) | 6.25 | 1.32 | A | A | A | A |
| TNR93 | (136) | (a) | 6.21 | 1.32 | A | A | A | A |
| TNR94 | (137) | (a) | 6.13 | 1.28 | A | A | A | A |
| TNR95 | (138) | (a) | 6.09 | 1.21 | A | A | A | A |
| TNR96 | (139) | (a) | 6.02 | 1.15 | A | A | A | A |
| TNR97 | (140) | (a) | 6.30 | 1.30 | A | A | A | A |
| TNR98 | (141) | (a) | 6.16 | 1.18 | A | A | A | A |
| TNR99 | (142) | (a) | 6.15 | 1.36 | A | A | A | A |
| TNR100 | (143) | (a) | 6.24 | 1.28 | A | A | A | A |
| TNR101 | (144) | (a) | 6.04 | 1.27 | A | A | A | A |
| TNR102 | (145) | (a) | 6.33 | 1.25 | A | A | A | A |
| TNR103 | (146) | (a) | 6.05 | 1.18 | A | A | A | A |
| TNR104 | (147) | (a) | 6.15 | 1.27 | A | A | A | A |
| TNR105 | (148) | (a) | 6.14 | 1.30 | A | A | A | A |
| TNR106 | (149) | (a) | 6.11 | 1.15 | A | A | A | A |
| TNR107 | (150) | (a) | 6.07 | 1.21 | A | A | A | A |
| TNR108 | (151) | (a) | 6.32 | 1.22 | A | A | A | A |
| TNR109 | (152) | (a) | 6.16 | 1.15 | A | A | A | A |
| TNR110 | (153) | (a) | 6.10 | 1.30 | A | A | A | A |
| TNR111 | (154) | (a) | 6.32 | 1.31 | A | A | A | A |
| TNR112 | (155) | (a) | 6.18 | 1.29 | A | A | A | A |
| TNR113 | (101) | (b) | 6.50 | 1.20 | B | B | B | B |
| TNR114 | (101) | (c) | 6.41 | 1.38 | B | B | B | B |
| TNR121 | None | (a) | 6.50 | 1.30 | — | D | D | D |
| TNR122 | None | (b) | 6.29 | 1.35 | — | D | D | D |
| TNR123 | None | (c) | 6.21 | 1.39 | — | D | D | D |
| TNR124 | Comparative | (a) | 6.54 | 1.26 | D | D | D | D |
| | Compound (1) | | | | | | | |
| TNR125 | Comparative | (a) | 6.59 | 1.24 | D | D | D | D |
| | Compound (2) | | | | | | | |
| TNR126 | Comparative | (a) | 6.54 | 1.28 | D | D | D | D |
| | Compound (3) | | | | | | | |

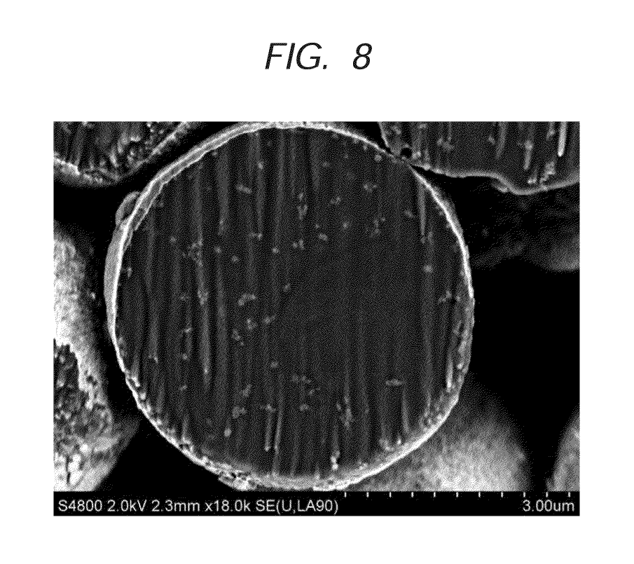

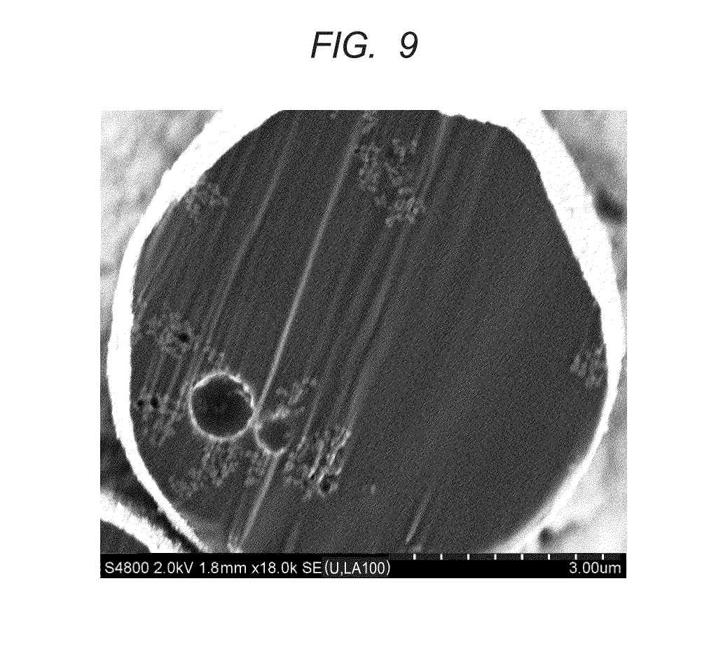

A cross-section of the synthesized toner was formed with a cross section polisher SM-09010 (manufactured by JEOL Ltd.). Carbon black in the cross-section of the toner was observed with a scanning electron microscope (hereinafter, abbreviated as SEM) S-4800 (manufactured by Hitachi High-Technologies Corporation). FIG. 8 shows a cross-sectional SEM photograph of TNR28, and FIG. 9 shows a cross-sectional SEM photograph of TNR115.

As apparent from Table 2, it was confirmed that the use of the compound having an azo skeleton structure improved the dispersibility of carbon black in a binding resin.

Further, as apparent from Table 3, it was confirmed that the use of the compound having an azo skeleton structure provided a black toner which had improved dispersibility of carbon black in a binding resin and had a satisfactory coloring power. It was also confirmed that the use of the compound having an azo skeleton structure provided a black toner which suppressed fogging and had high transfer efficiency.

Further, as apparent from Table 4, it was confirmed that, also in the suspension granulation method, the use of the compound having an azo skeleton structure provided a black toner which had improved dispersibility of carbon black in a binding resin and had a satisfactory coloring power, and also provided a black toner which suppressed fogging and had high transfer efficiency.

In addition, as apparent from FIG. 8 and FIG. 9, it was confirmed that the use of the compound having an azo skeleton structure allowed carbon black to be satisfactorily dispersed in a toner as well.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-043072, filed Jan. 29, 2012 which is hereby incorporated by reference herein in its entirety.

1. A black toner, comprising a toner particle comprising:
a binding resin;
a compound in which a partial structure represented by the following formula (1) is bound to a polymer moiety having a monomer unit represented by the following formula (2); and
carbon black as a coloring agent: 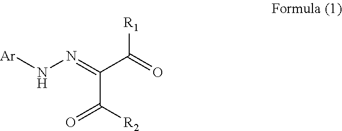
in the formula (1):
at least one of R₁, R₂, and Ar is bound to the polymer moiety with a linking group or a single bond;
R₁ and R₂ not bound to the polymer moiety each independently represent an alkyl group, a phenyl group, an OR₅ group, or an NR₆R₇ group, and Ar not bound to the polymer moiety represents an aryl group;
R₁ bound to the polymer moiety and R₂ bound
to the polymer moiety each independently represent a divalent group obtained by removing a hydrogen atom from an alkyl group, a phenyl group, or an OR₅ or NR₆R₇ group, and Ar bound to the polymer moiety represents a divalent group obtained by removing a hydrogen atom from an aryl group; and
R₅ to R₇ each independently represent a hydrogen atom, an alkyl group, a phenyl group, or an aralkyl group; and 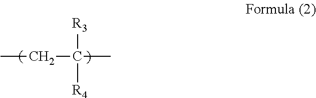
in the formula (2):
R₃ represents a hydrogen atom or an alkyl group; and
R₄ represents a phenyl group, a carboxyl group, a carboxylic acid ester group, or a carboxylic acid amide group.

2. The black toner according to claim 1, wherein the partial structure represented by the formula (1) is represented by the following formula (3): 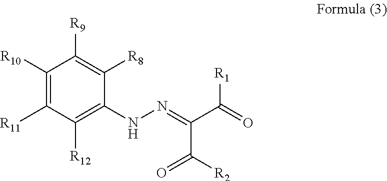
in the formula (3):
R₁ and R₂ each independently represent an alkyl group, a phenyl group, an OR_{S} group, or an NR₆R₇ group;
R₈ to R₁₂ each independently represent a hydrogen atom, a COOR₁₃ group, or a CONR₁₄R₁₅ group;
R₁₃ to R₁₅ each independently represent a hydrogen atom, an alkyl group, a phenyl group, or an aralkyl group; and
at least one of R₁, R₂, and R₈ to R₁₂ has a moiety to be bound to the polymer moiety.

3. The black toner according to claim 1,
wherein R₂ in the formula (1) represents an NR₆R₇ group, where R₆ represents a hydrogen atom and R₇ represents a phenyl group.

4. The black toner according to claim 1, wherein R₂ in the formula (1) represents an NR₆R₇ group, where R₆ represents a hydrogen atom and R₇ represents a phenyl group having a moiety to be bound to the polymer moiety.

5. The black toner according to claim 1, wherein at least one substituent group by which Ar in the formula (1) is substituted comprises one of a COOR₁₃ group and a CONR₁₄R₁₅ group, where R₁₃ to R₁₅ each independently represent a hydrogen atom, an alkyl group, a phenyl group, or an aralkyl group.

6. The black toner according to claim 1, wherein the partial structure represented by the formula (1) is bound to the polymer moiety having the monomer unit represented by the formula (2) via one of a carboxylic acid ester bond and a carboxylic acid amide bond.

7. The black toner according to claim 1, wherein the partial structure represented by the formula (1) is represented by the following formula (4): 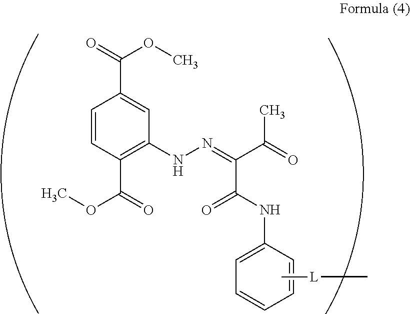
where L represents a divalent linking group to be bound to the polymer moiety having the monomer unit represented by the formula (2).

8. The black toner according to claim 1, wherein the partial structure represented by the formula (1) is represented by the following formula (5): 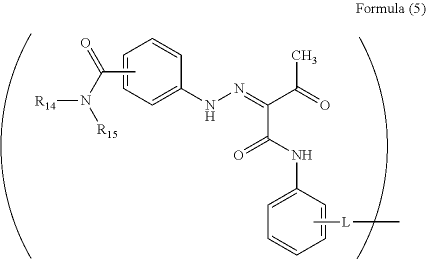
in the formula (5):
R₁₄ and R₁₅ each independently represent a hydrogen atom, an alkyl group, a phenyl group, or an aralkyl group; and
L represents a divalent linking group to be bound to the polymer moiety having the monomer unit represented by the formula (2).

9. The black toner according claim 1, wherein the toner particle is produced through use of one of a suspension polymerization method and a suspension granulation method.
